(19) United States
(12) Patent Application Publication
(10) Pub. No.: US 2010/0283904 A1
(43) Pub. Date: Nov. 11, 2010

(54) RELAY CONNECTOR, MOUNTING STRUCTURE OF RELAY CONNECTOR AND CHASSIS, MOUNTING STRUCTURE OF RELAY CONNECTOR AND POWER SOURCE, MOUNTING STRUCTURE OF DISCHARGE TUBE AND POWER SOURCE TO RELAY CONNECTOR, LIGHTING DEVICE FOR DISPLAY DEVICE, DISPLAY DEVICE AND TELEVISION RECEIVER

(75) Inventors: Yoshiki Takata, Osaka-shi (JP); Takaaki Kudo, Shibuya-ku (JP); Naofumi Ikenaga, Shibuya-ku (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignees: SHARP KABUSHIKI KAISHA, Osaka-shi, Osaka (JP); JAPAN AVIATION ELECTRONICS INDUSTRY, LIMITED, Shibuya-ku, Tokyo (JP)

(21) Appl. No.: 12/743,654

(22) PCT Filed: Sep. 17, 2008
(86) PCT No.: PCT/JP2008/066720

§ 371 Date: May 19, 2010

(30) Foreign Application Priority Data
Dec. 27, 2007 (JP) 2007-337107

(51) Int. Cl. H04N 5/44; F21V 21/00; G09F 13/04; G02F 1/13357

(52) U.S. Cl. 348/725; 362/217.15; 362/97.1; 349/61; 348/E05.096

(57) ABSTRACT

A relay connector 145 of the present invention is provided for supplying power from a power source (a power supply board) arranged on a rear surface side of a chassis 13 to a discharge tube 15 arranged on a front surface side of the chassis 13. It includes a holder 20 having insulation properties and mounted to the chassis 13, and a relay terminal mounted to the holder 20 and electrically connectable to a discharge tube 15 and the power source 16. A space 149 is provided between the chassis 13 and the power source 16. The holder 20 includes a protective wall portion 146 provided in the space 149 between the chassis 13 and the power source 16 and configured to cover the relay terminal from outside.

### TECHNICAL FIELD

The present invention relates to a relay connector, a mounting structure of a relay connector and a chassis, a mounting structure of a relay connector and a discharge tube, a mounting structure of a relay connector and a power source, a mounting structure of a discharge tube and a power source to a relay connector, a lighting device, a display device and a television receiver.

### BACKGROUND ART

Patent Document 1 discloses a lighting device that functions as a backlight of a liquid crystal display device. The lighting device includes relay terminals mounted on a chassis having a substantially plate shape. Ends of the relay terminals on one side are connected to a plurality of elongated discharge tubes, and ends thereof on the other side are connected to a power source. Power is supplied from the power source to the discharge tubes via the relay terminals.

Patent Document 1: Japanese Unexamined Patent Publication No. 2004-294592

### Problem to be Solved by the Invention

In the above known device, bare relay terminals are directly attached to the chassis. Thus, electrical leakage or shock needs to be taken into consideration for designing.

### DISCLOSURE OF THE PRESENT INVENTION

The present invention was made in view of the foregoing circumstances. An object of the present invention is to provide relay connectors that are in a power supply path from a power source to discharge tubes and less likely to produce electrical leakage and shock.

### Means for Solving the Problem

To achieve the above object, relay connectors of the present invention are provided for supplying power from a power source arranged on a rear side of a chassis to discharge tubes arranged in front of the chassis having a substantially plate shape. Each relay connector includes a holder having insulation properties and attached to the chassis. It also includes a relay terminal that is mounted to the holder and electrically connectable to the discharge tube and the power source. The chassis and the power source are separated from each other with a gap therebetween. The holder includes a protective wall portion provided in the gap between said chassis and said power source, and configured to cover the relay terminal from outside.

By providing a wall portion between the chassis and the power source, the relay terminal is not exposed in the gap. Therefore, the relay terminal in the gap is protected from being touched or less likely to be touched by a person in production. As a result, relay connectors that are less likely to cause electrical leakage or shock can be provided.

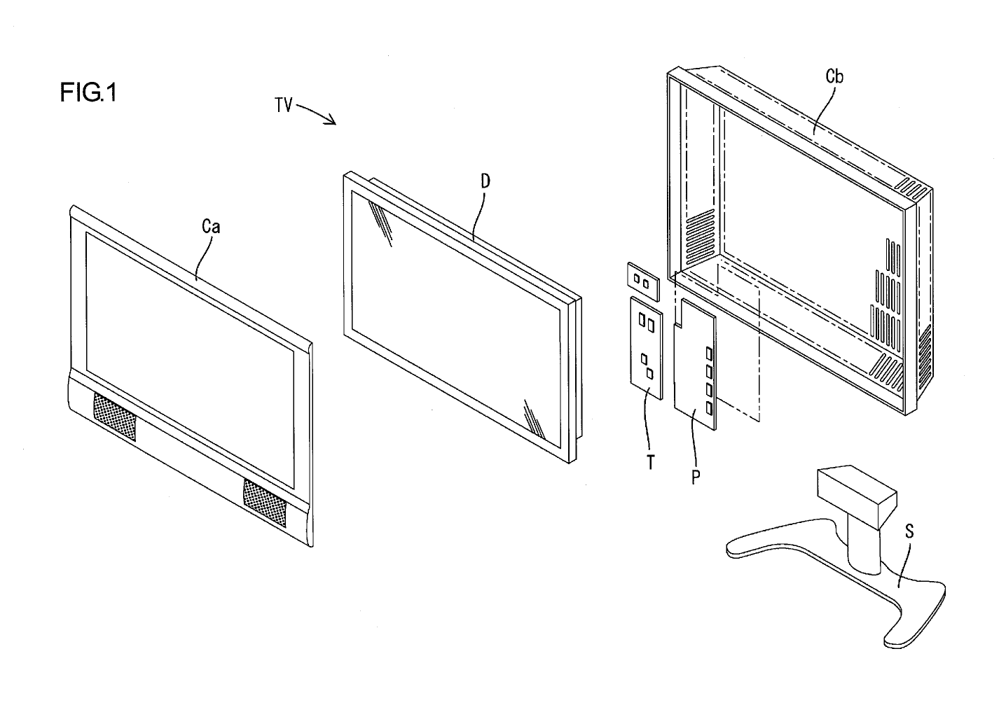

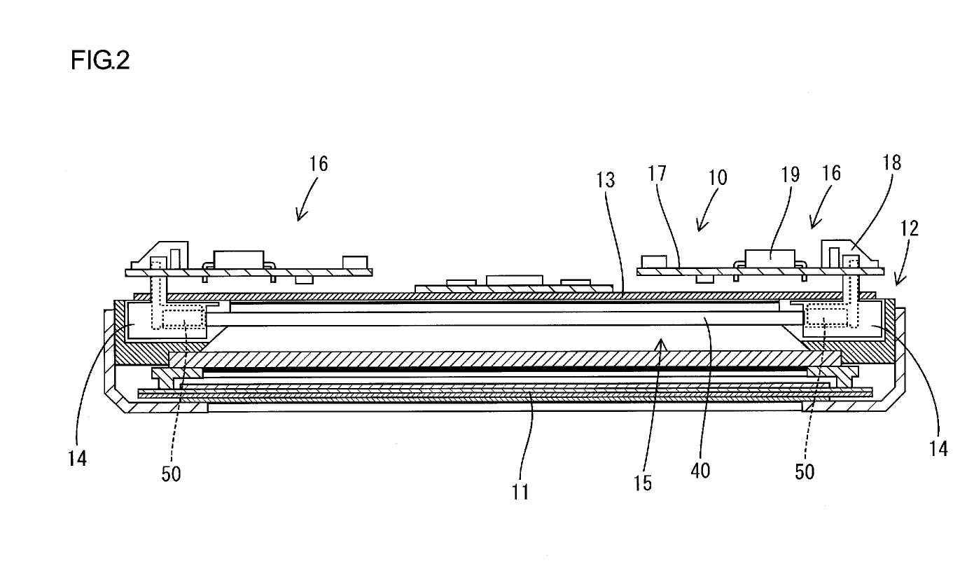

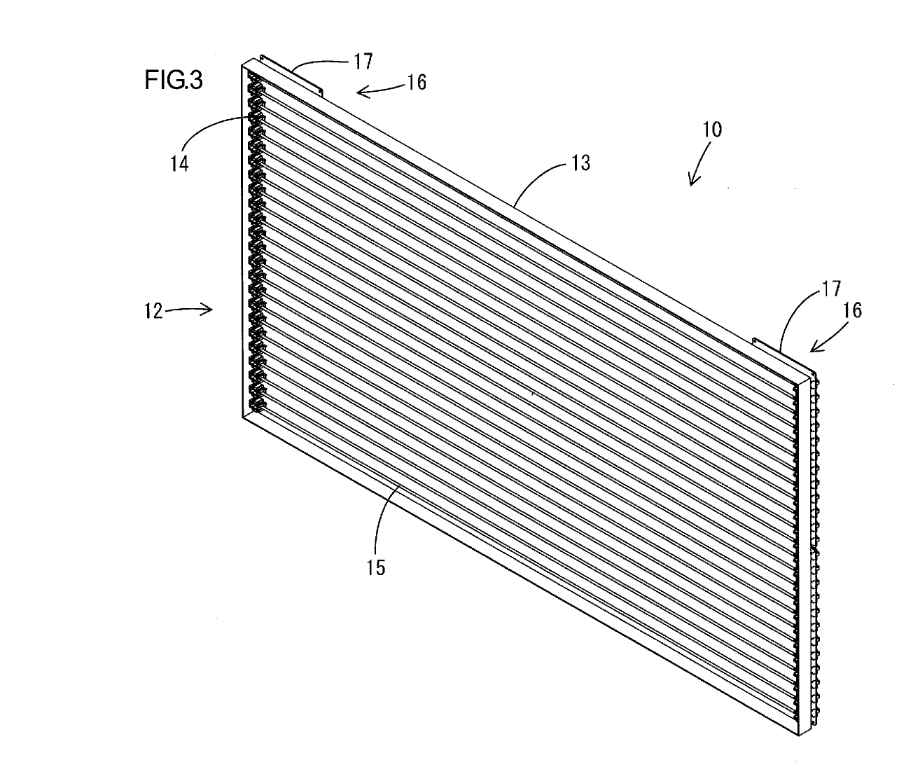

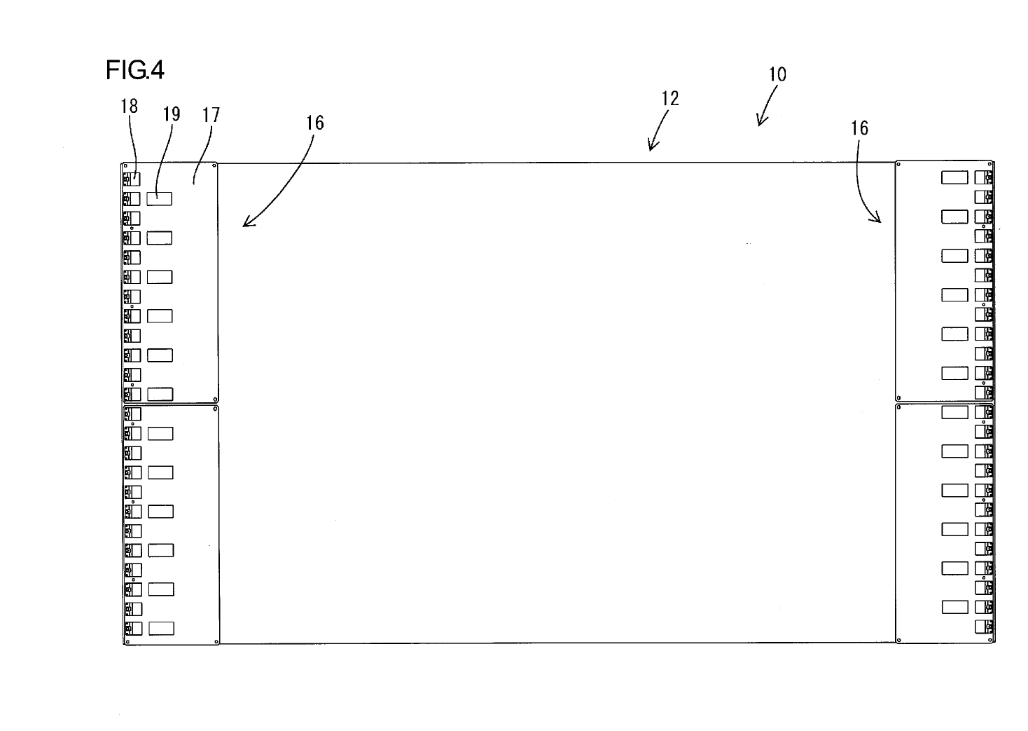

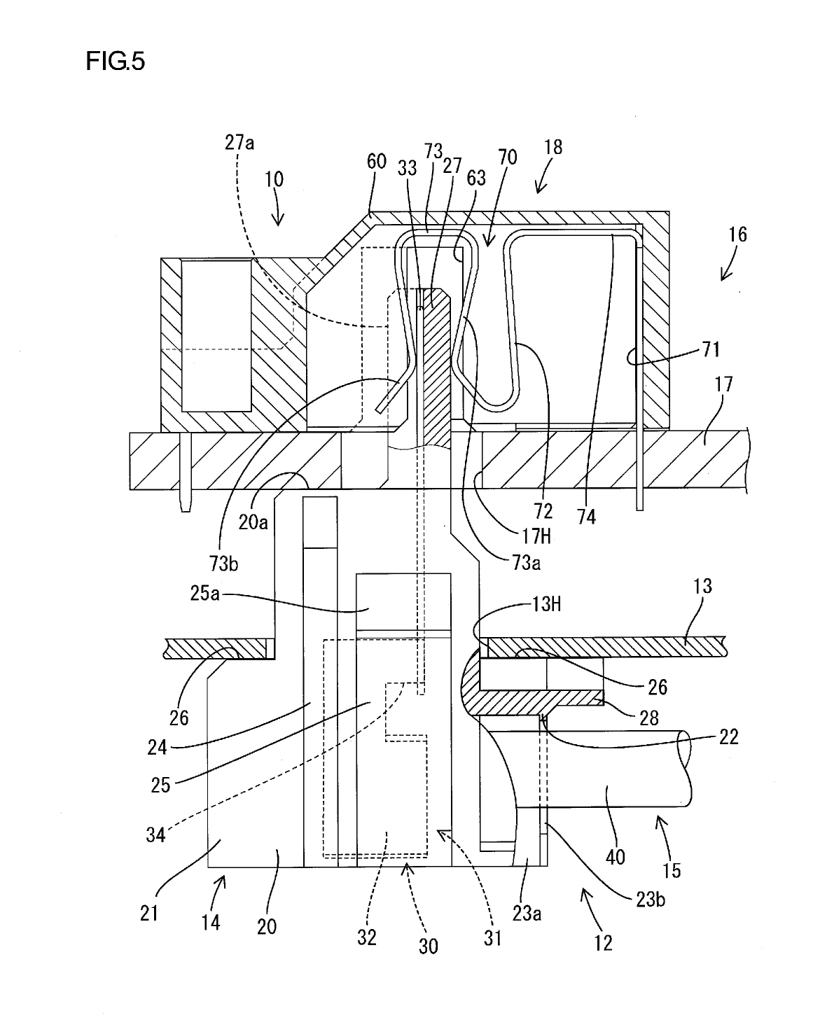

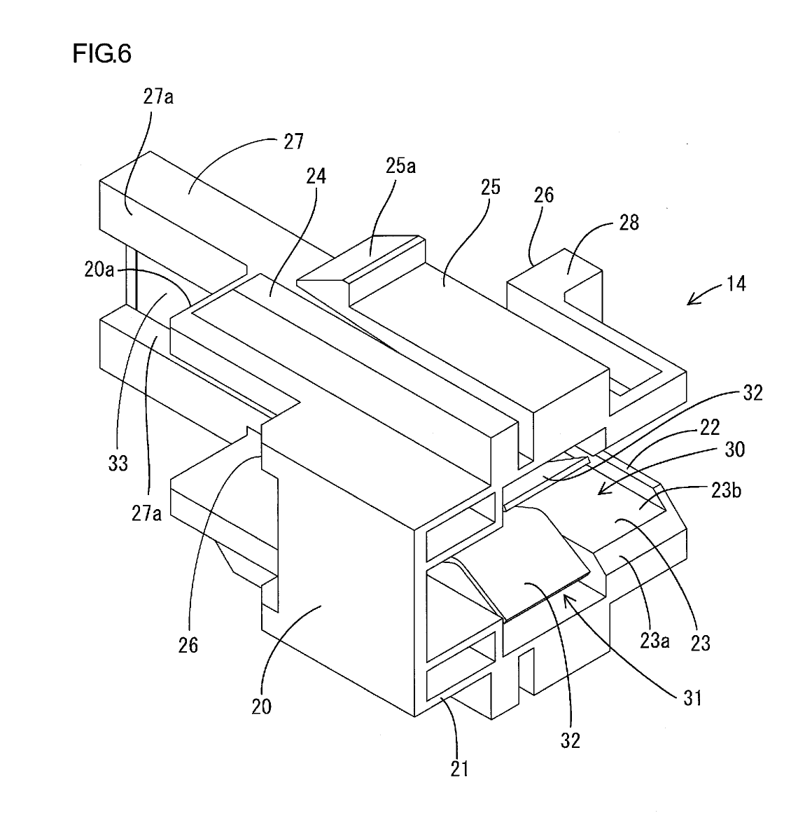

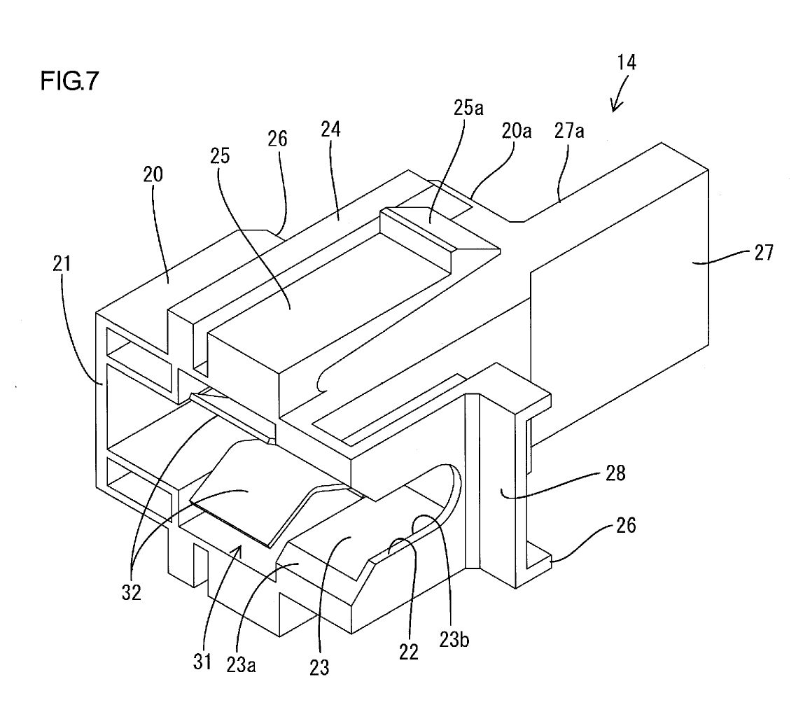

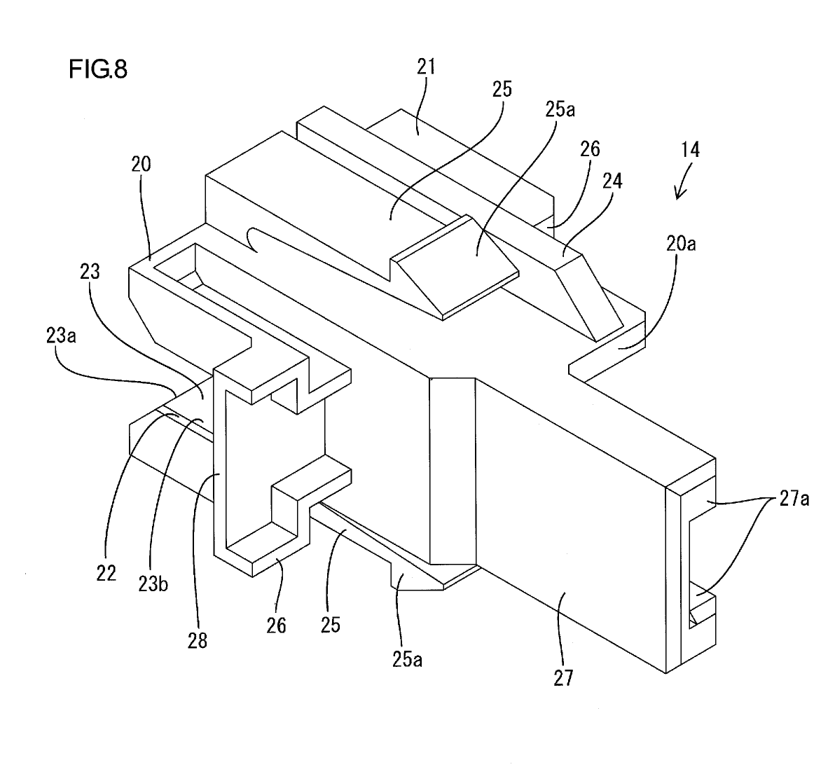

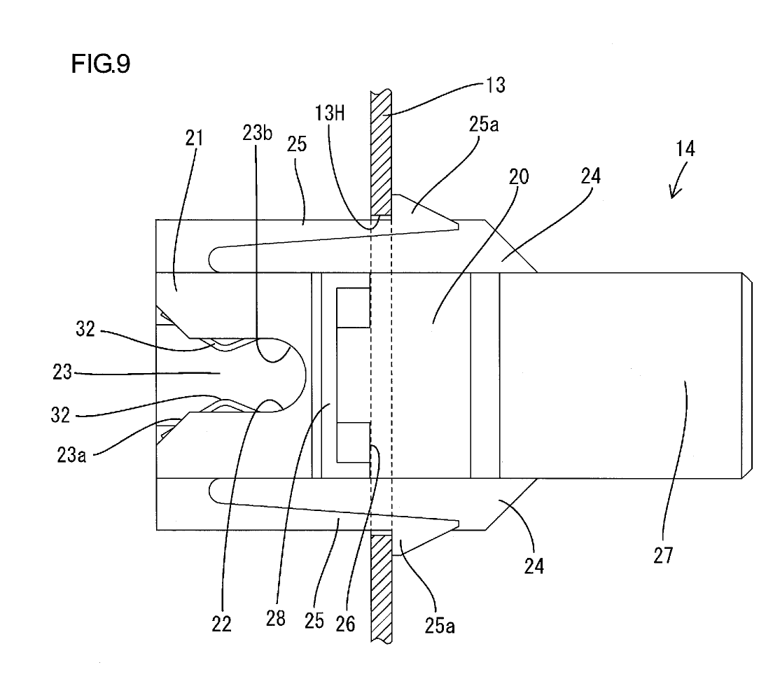

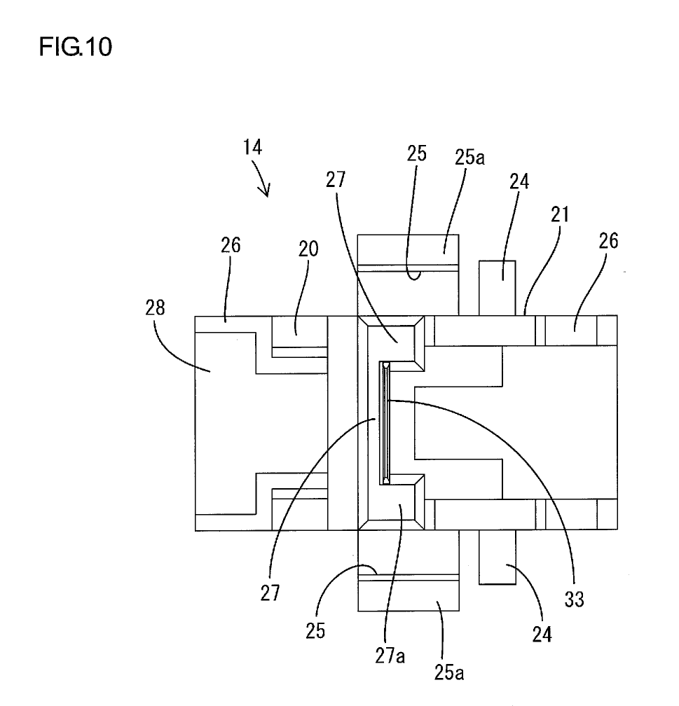

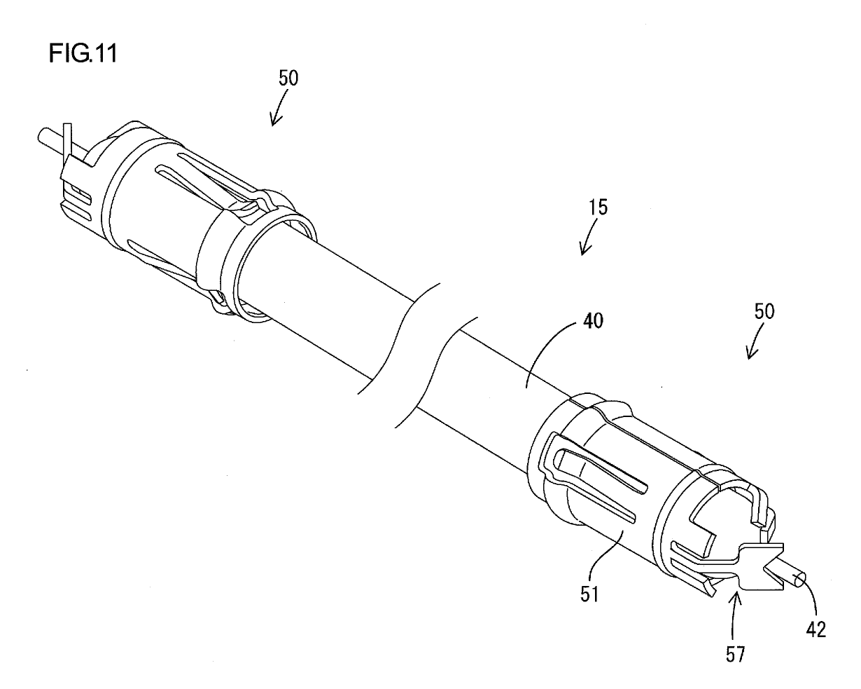

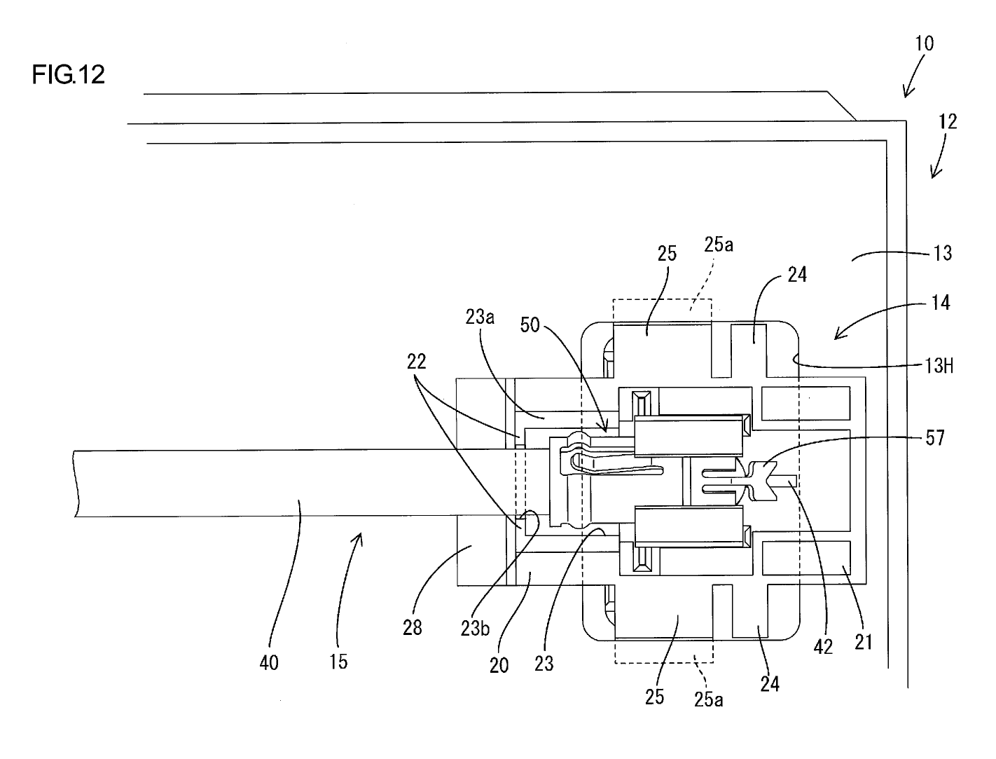

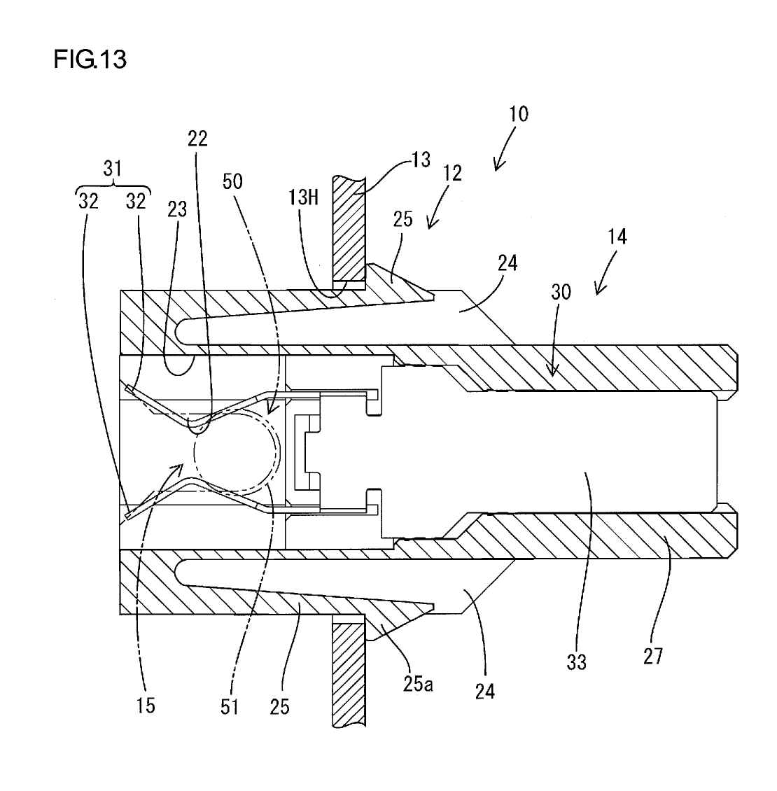

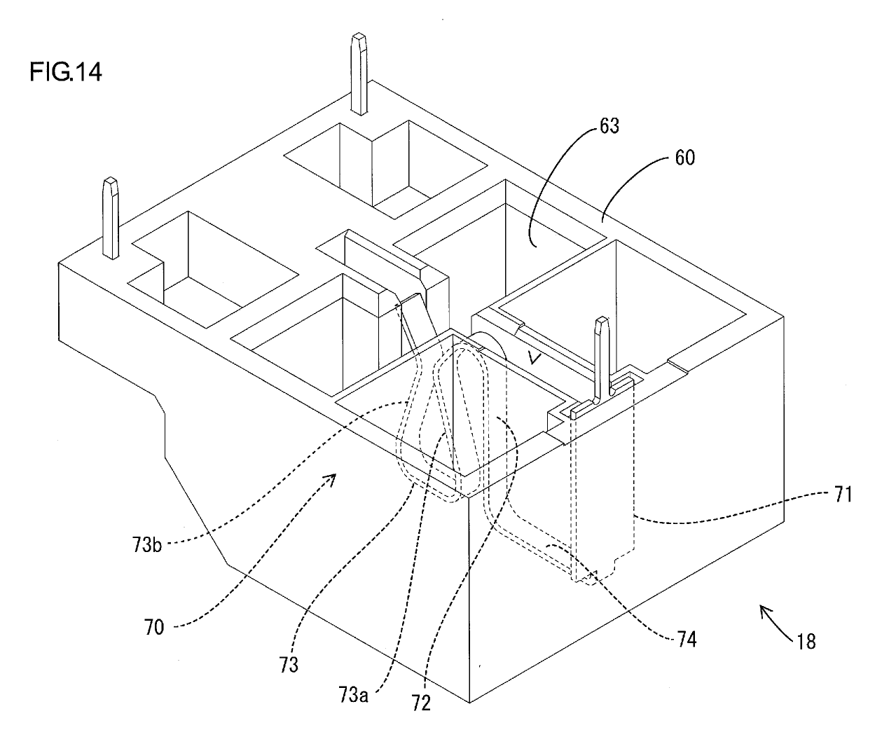

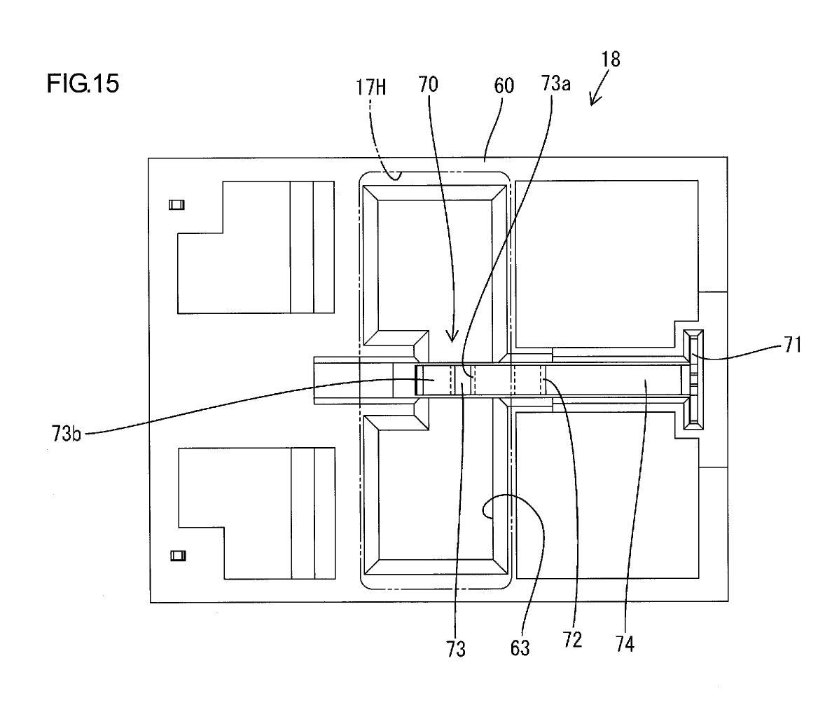

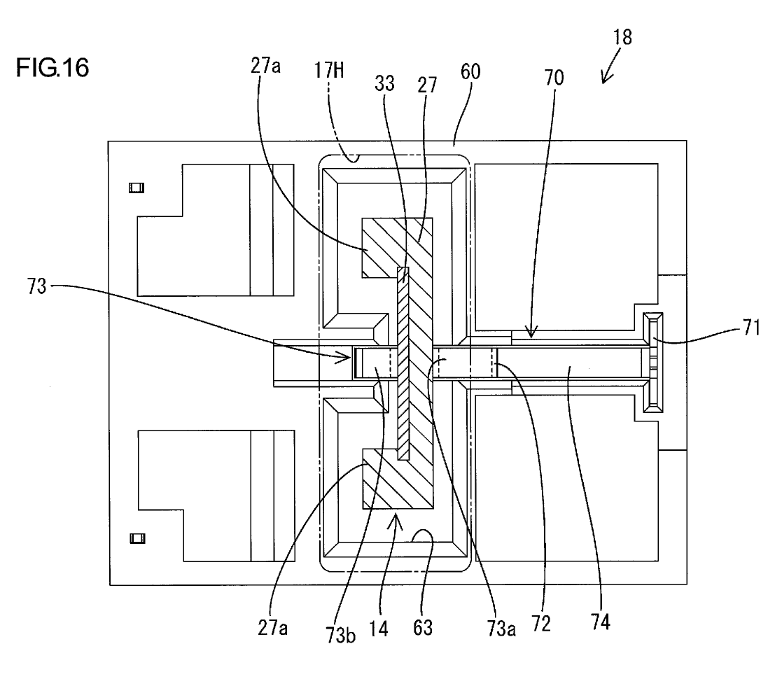

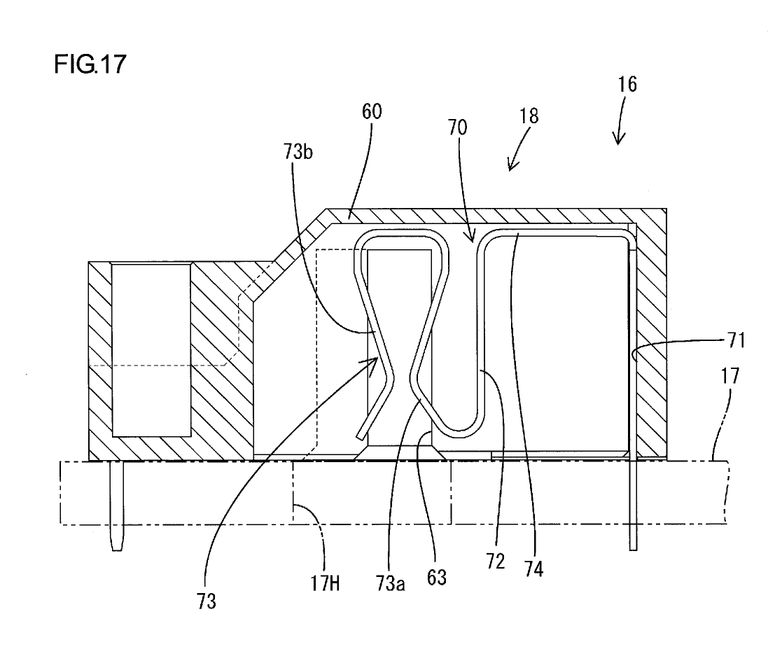

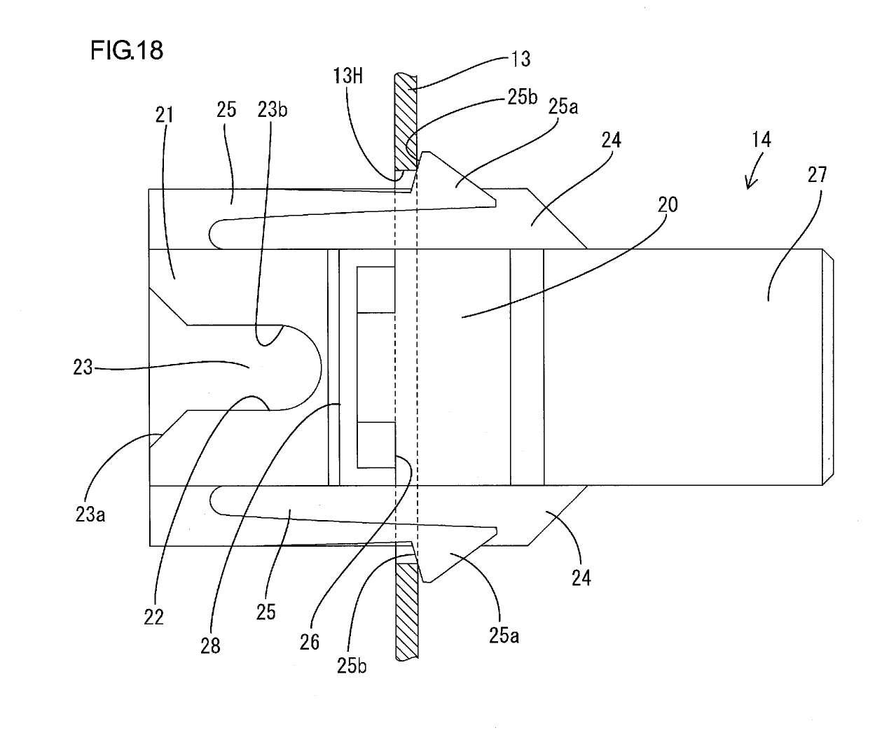

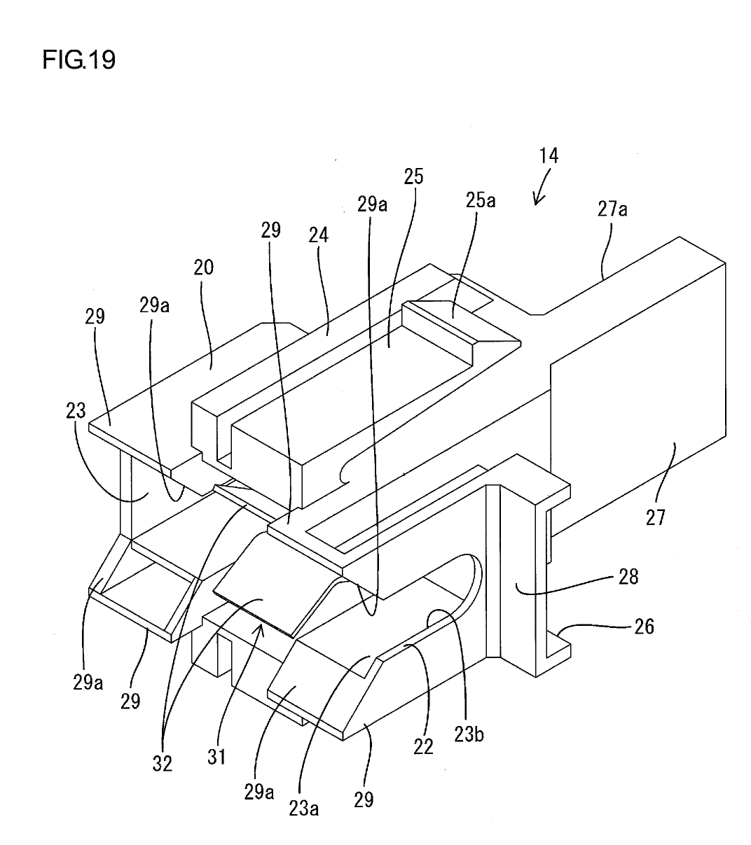

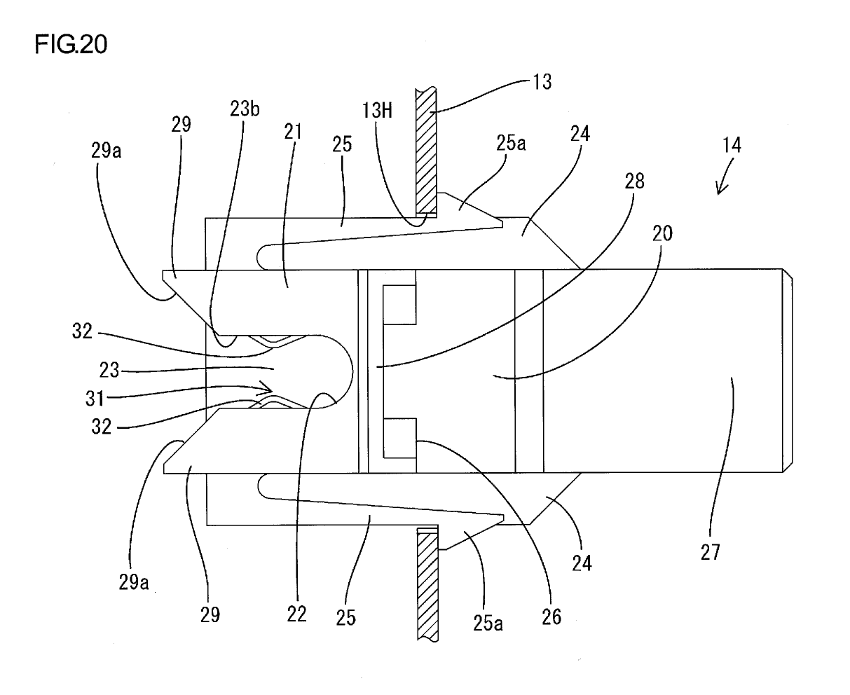

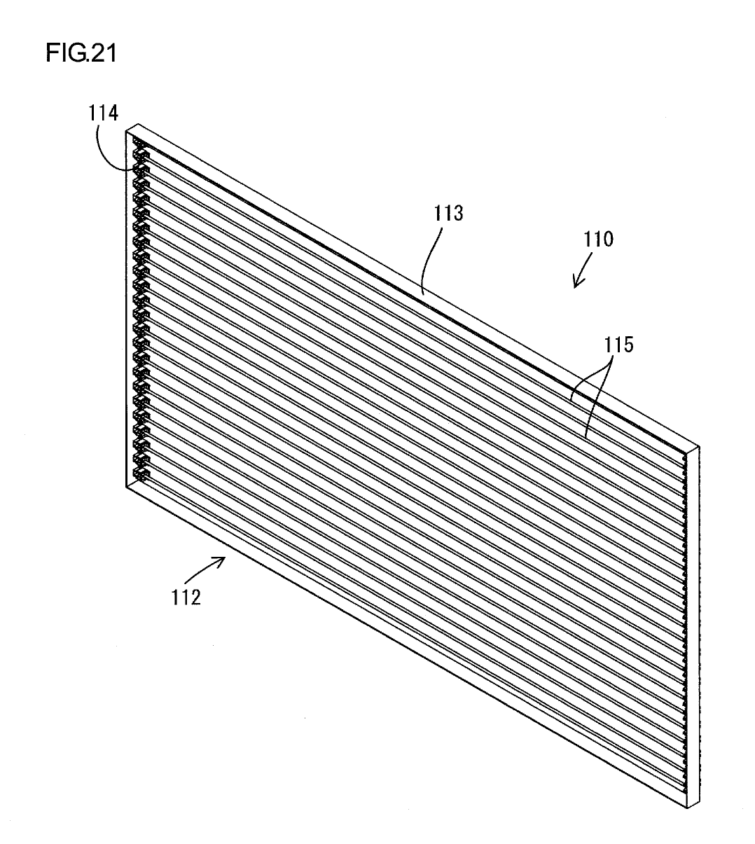

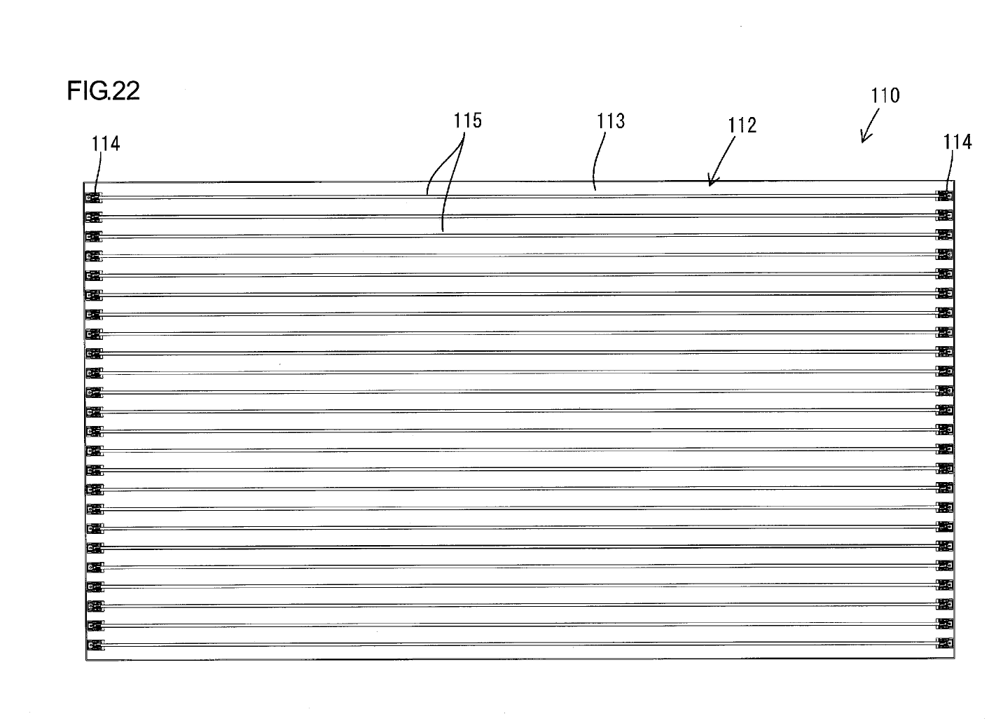

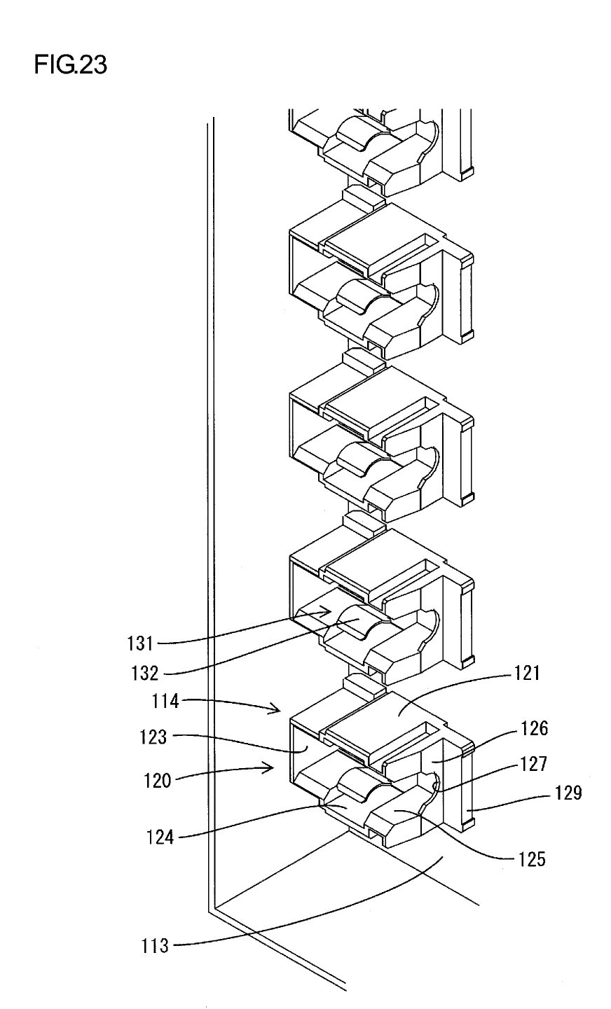

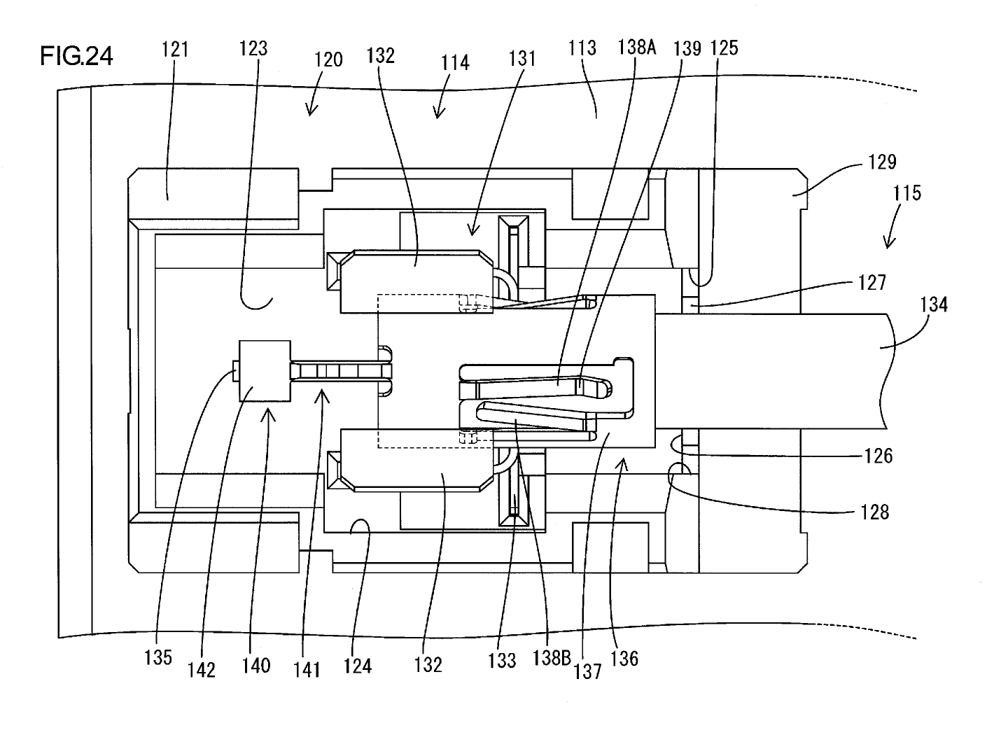

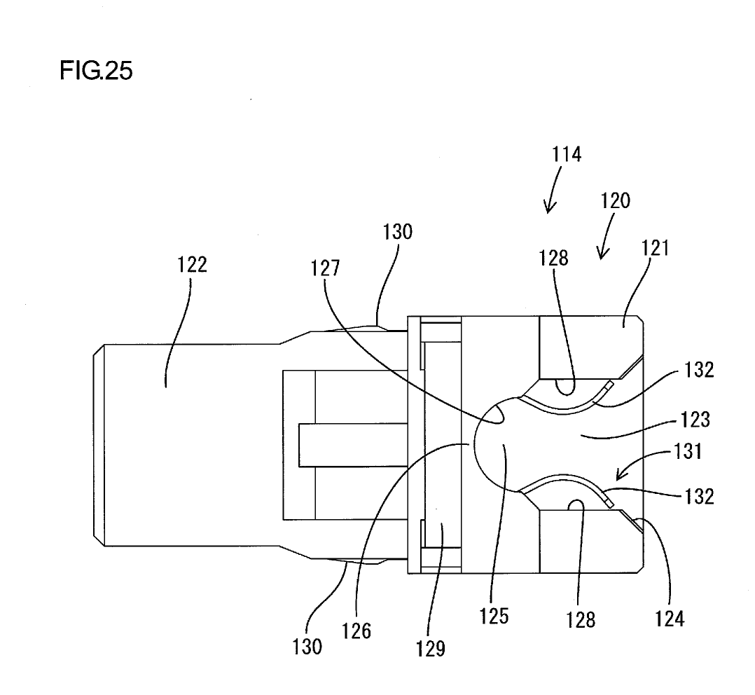

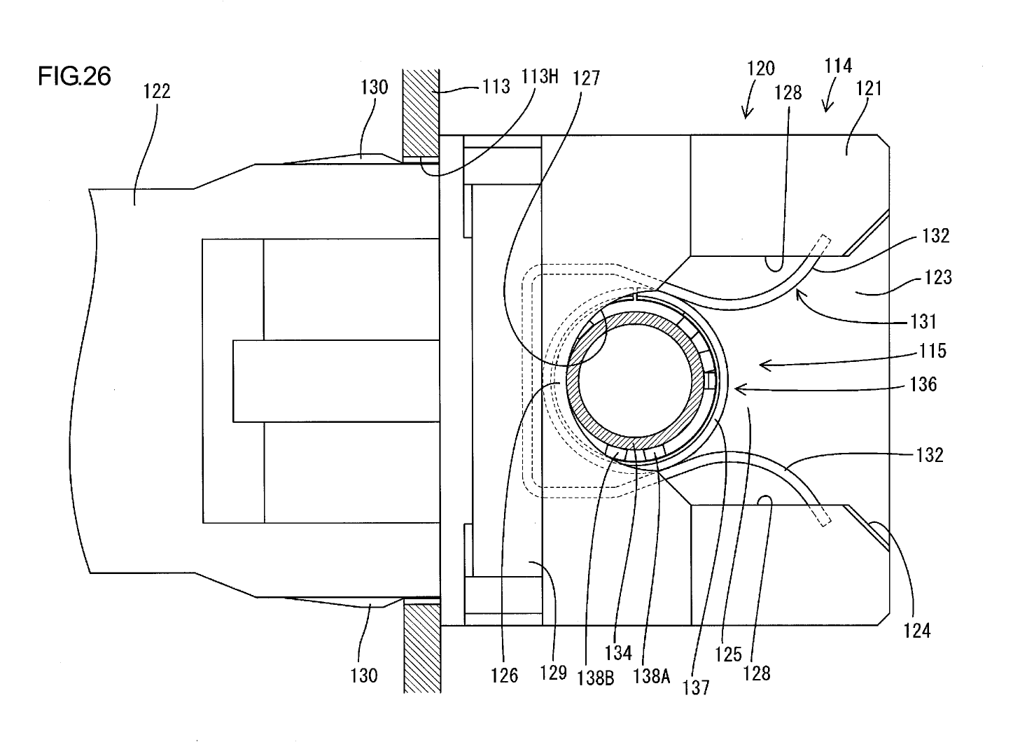

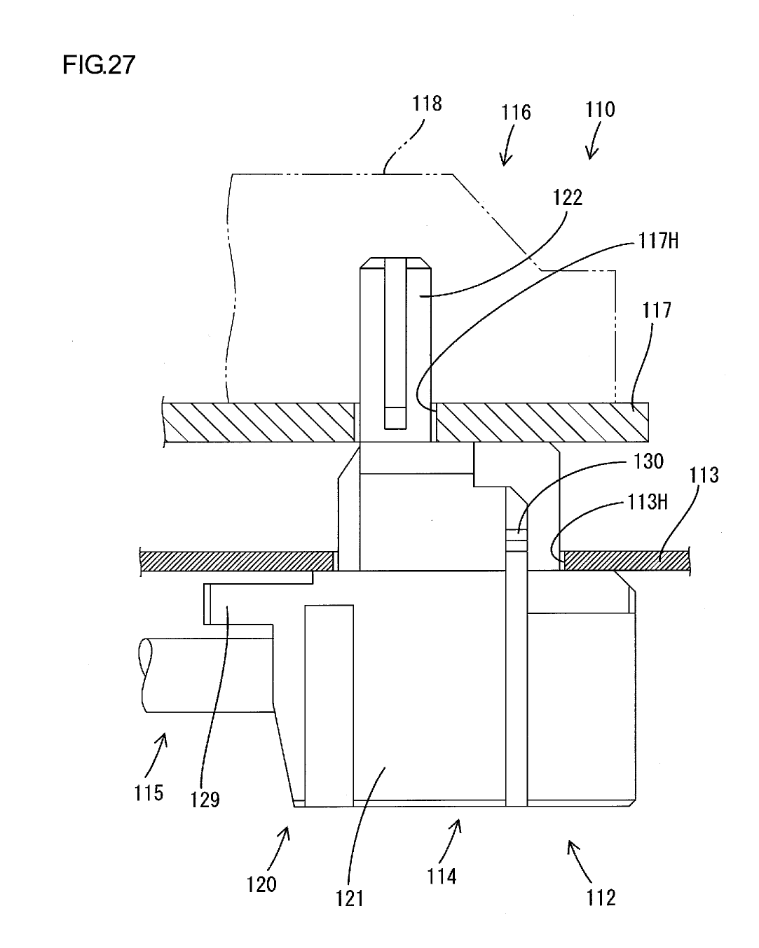

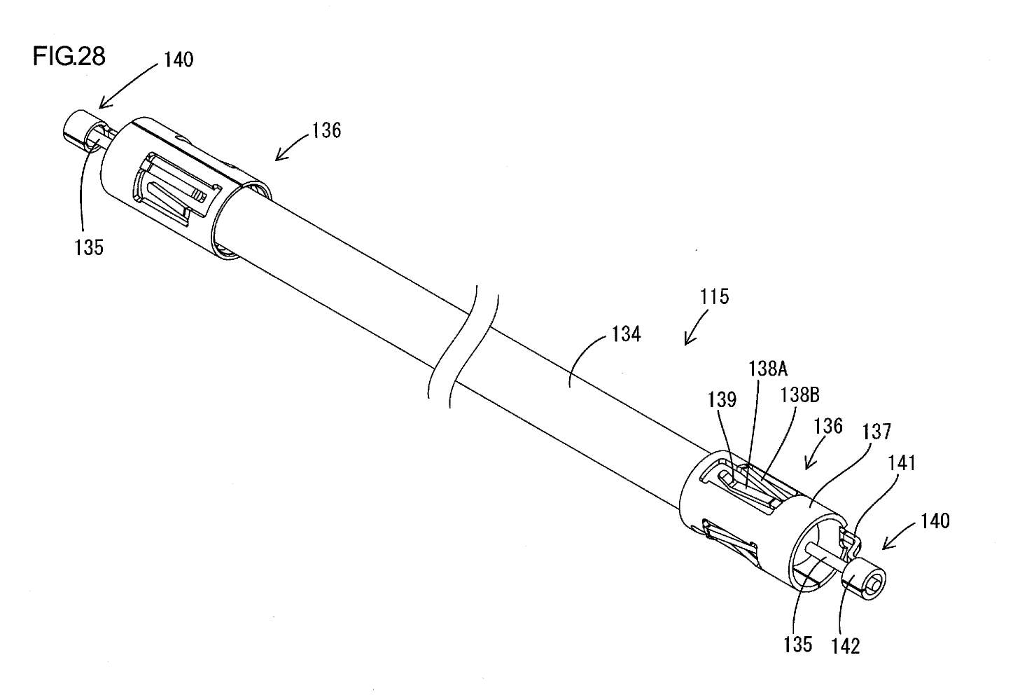

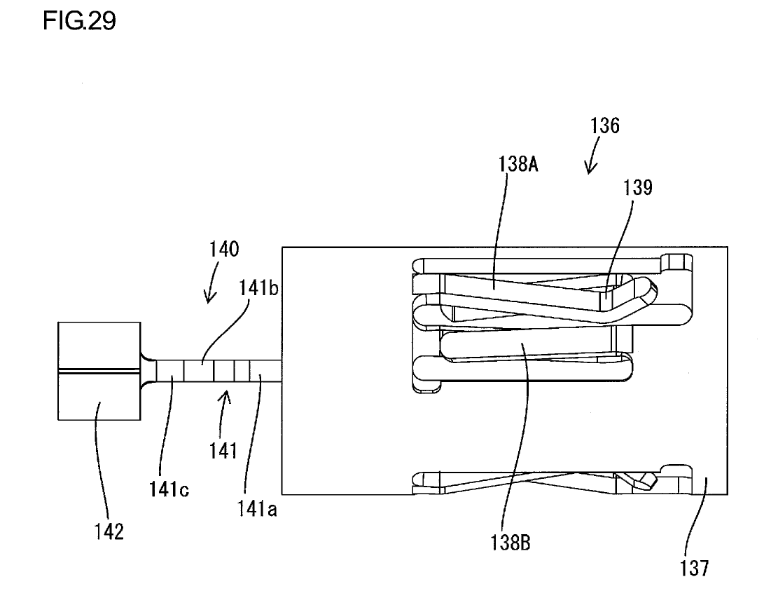

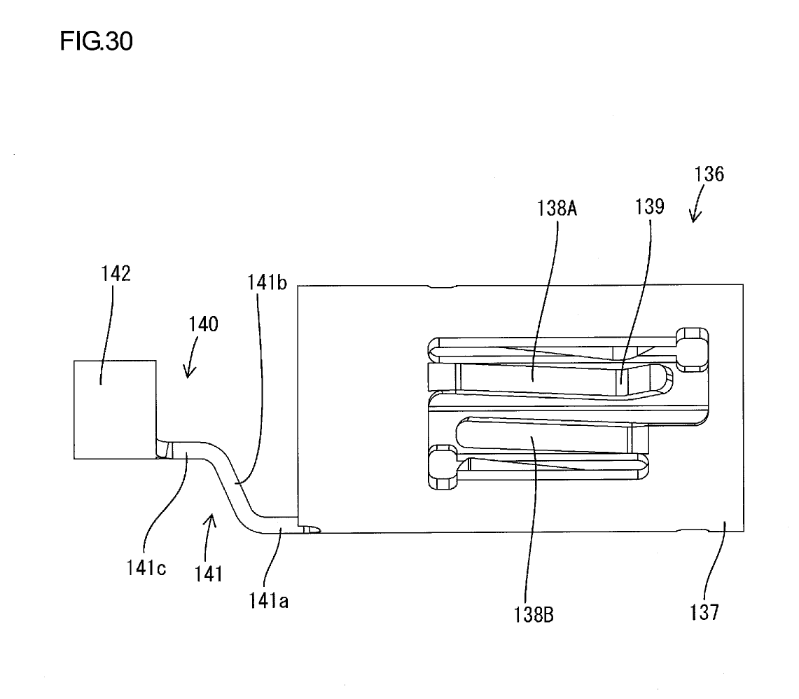

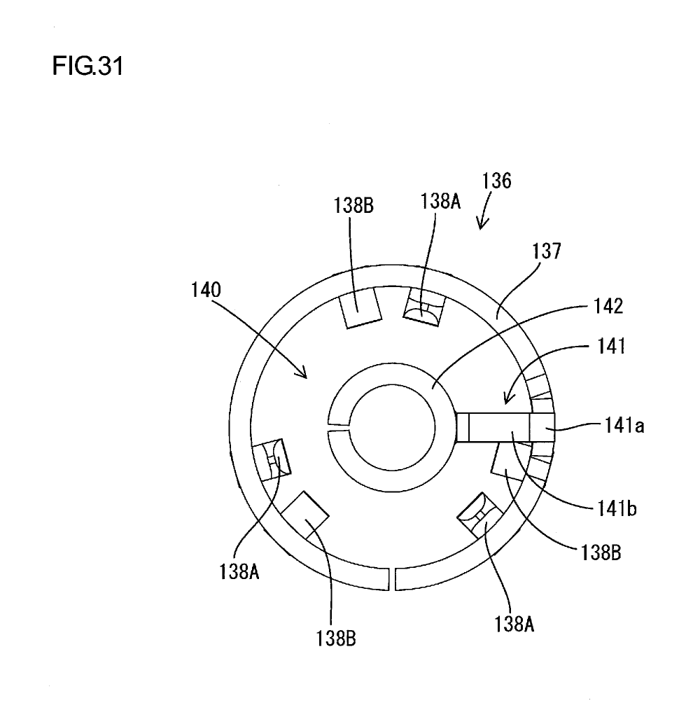

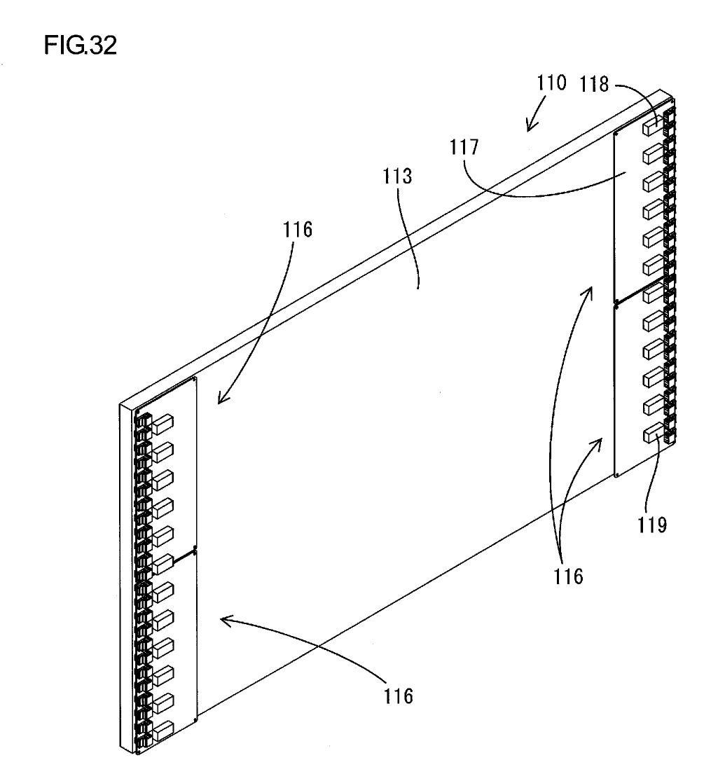

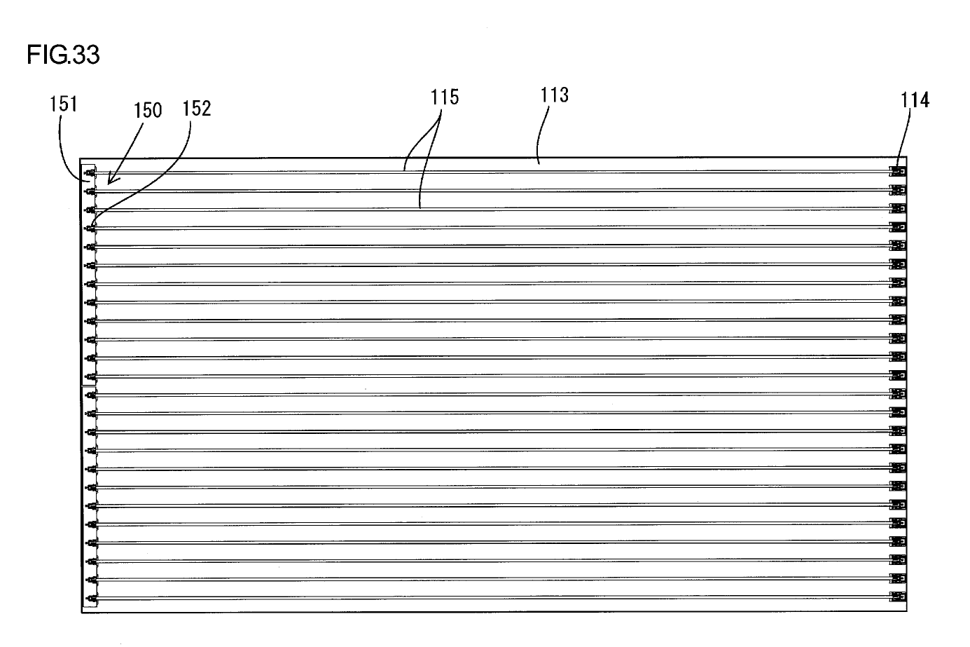

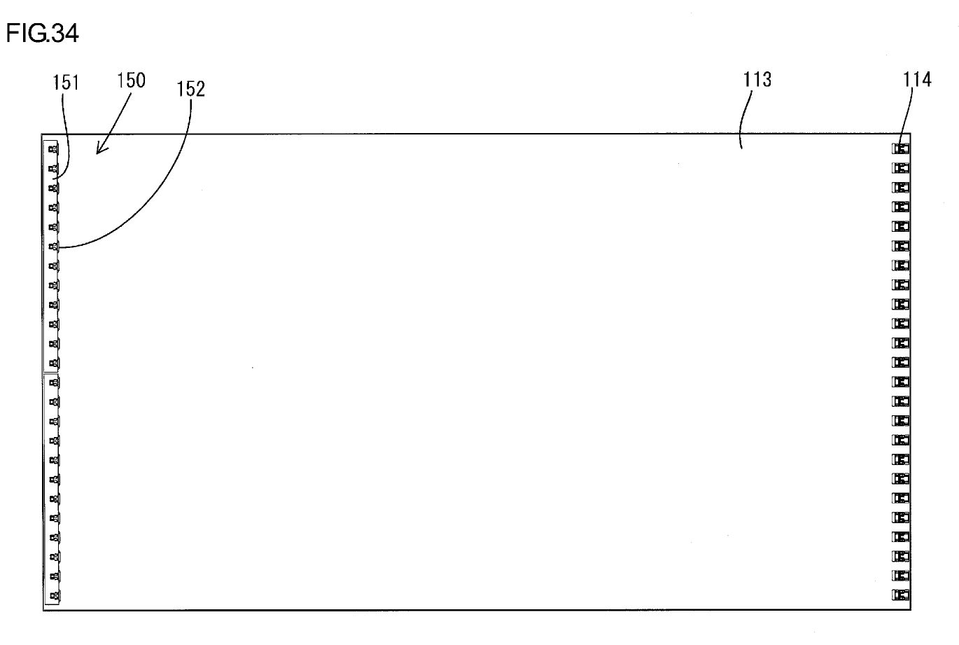

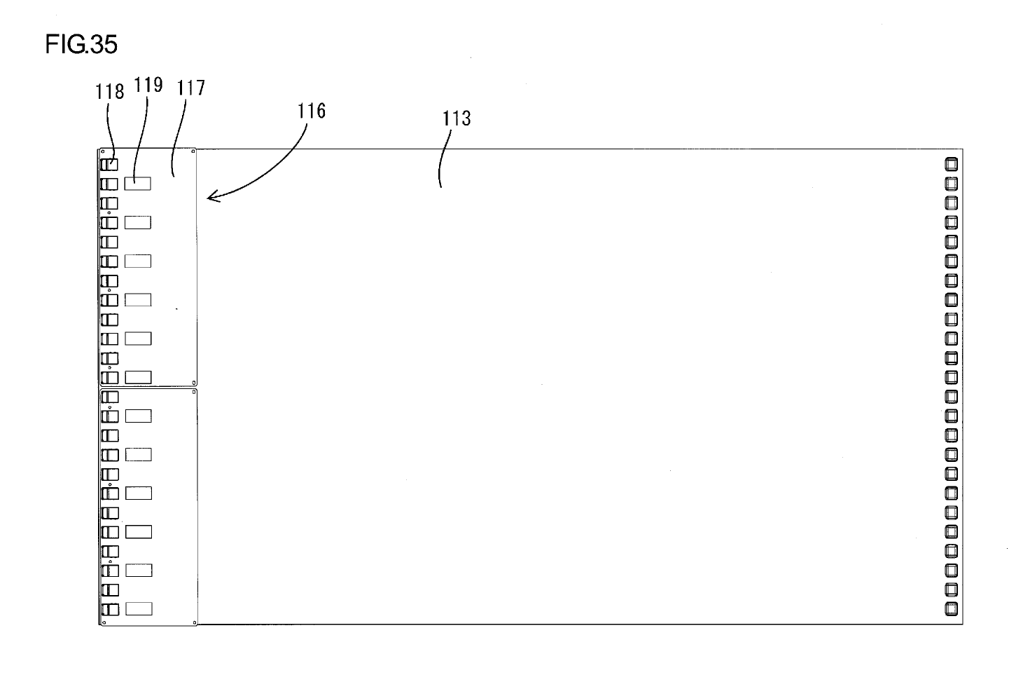

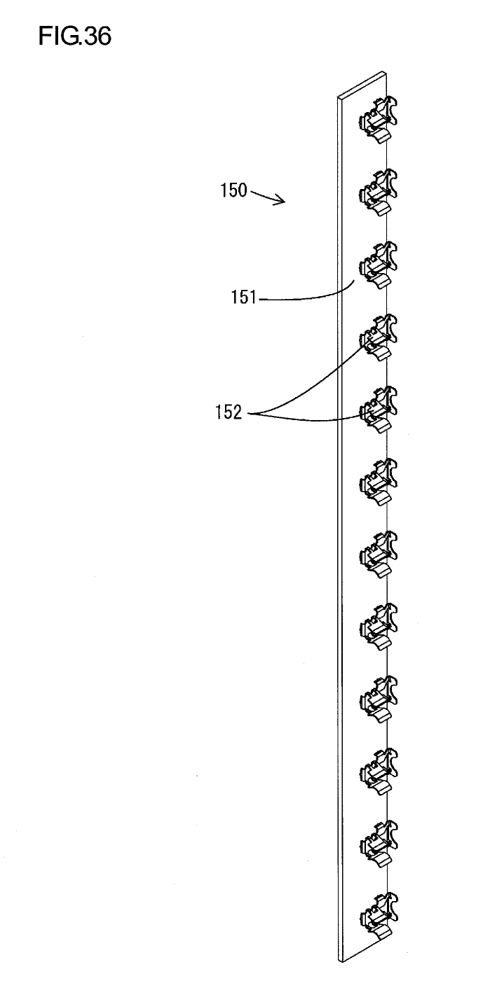

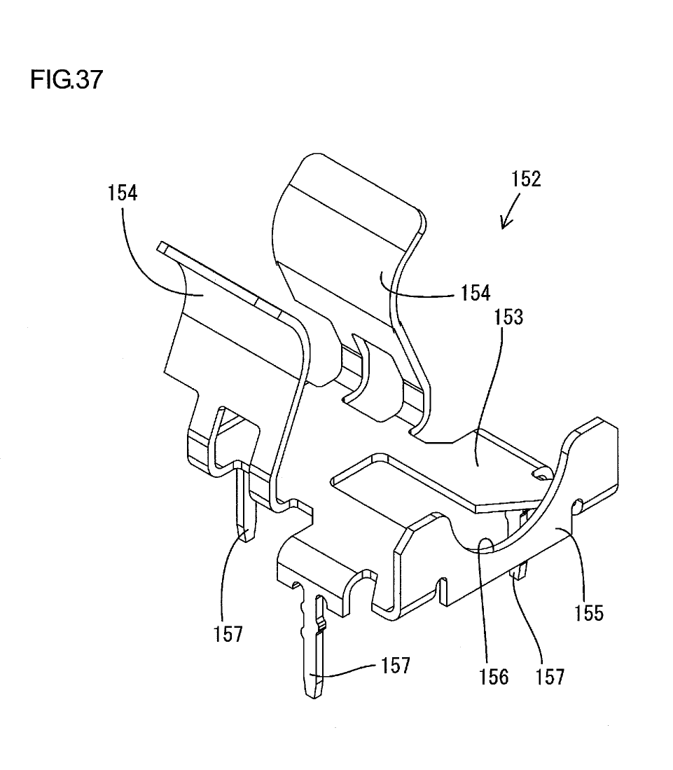

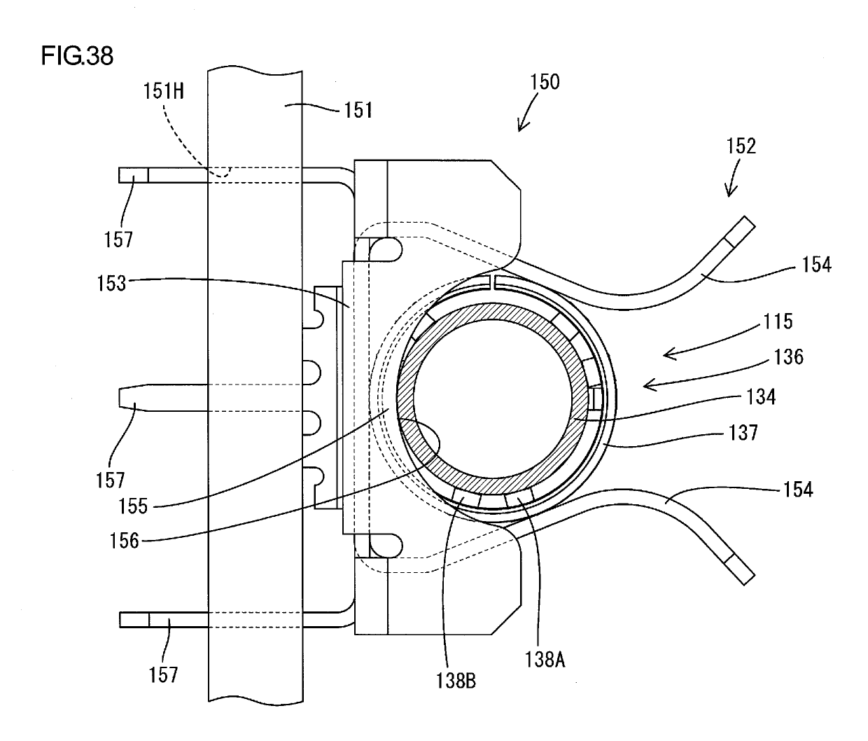

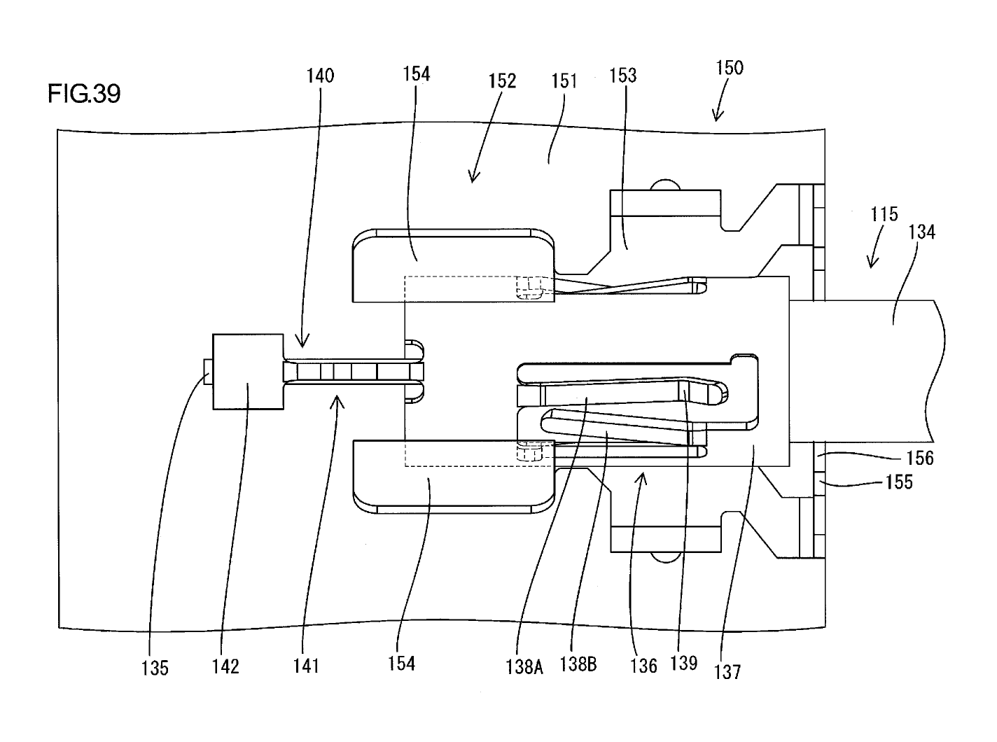

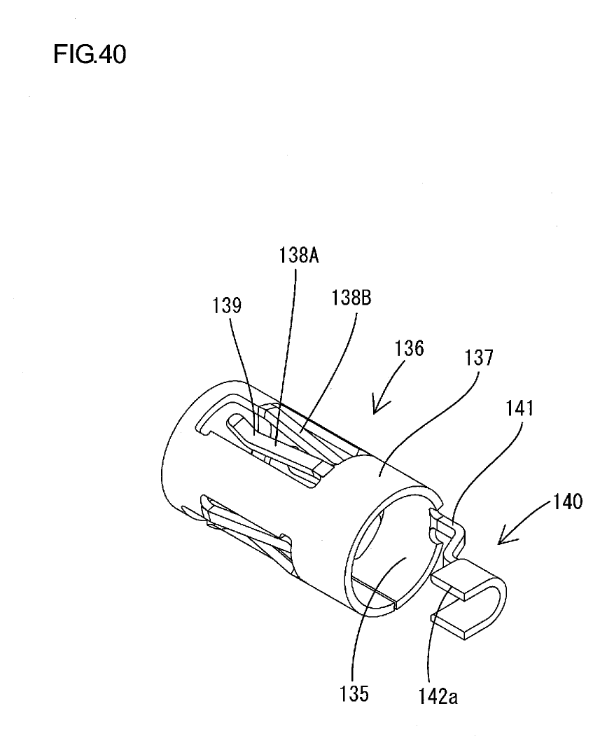

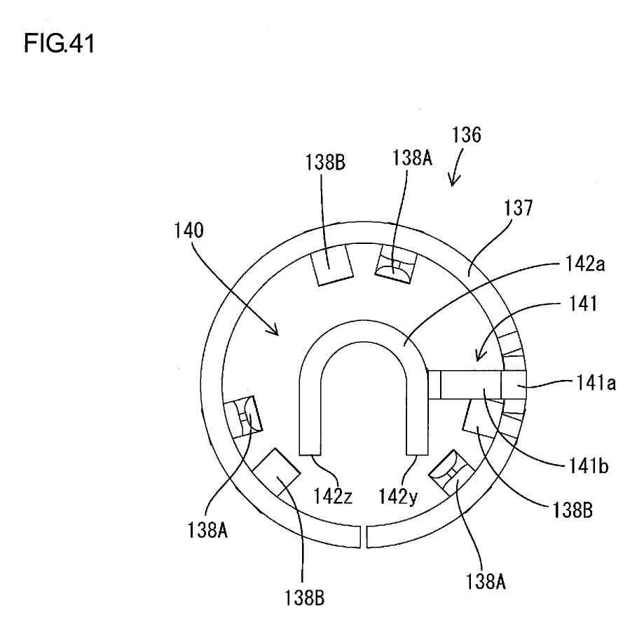

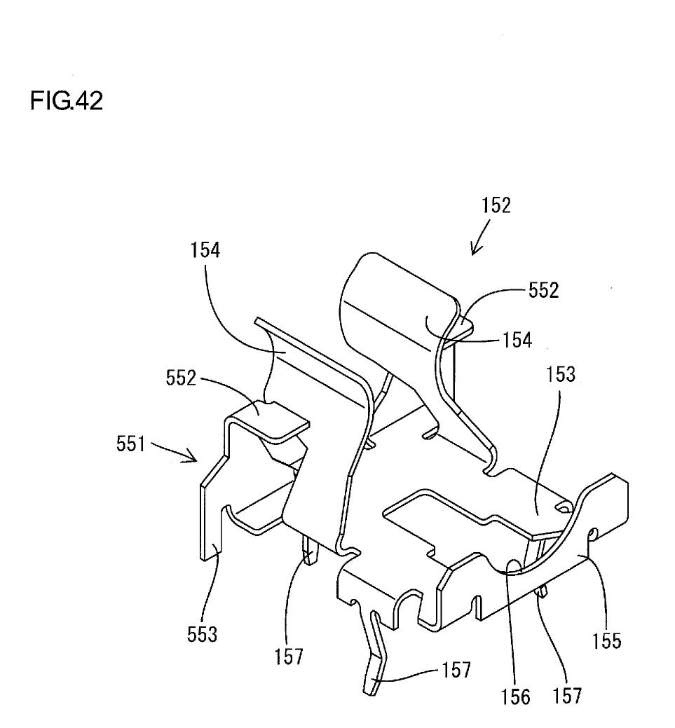

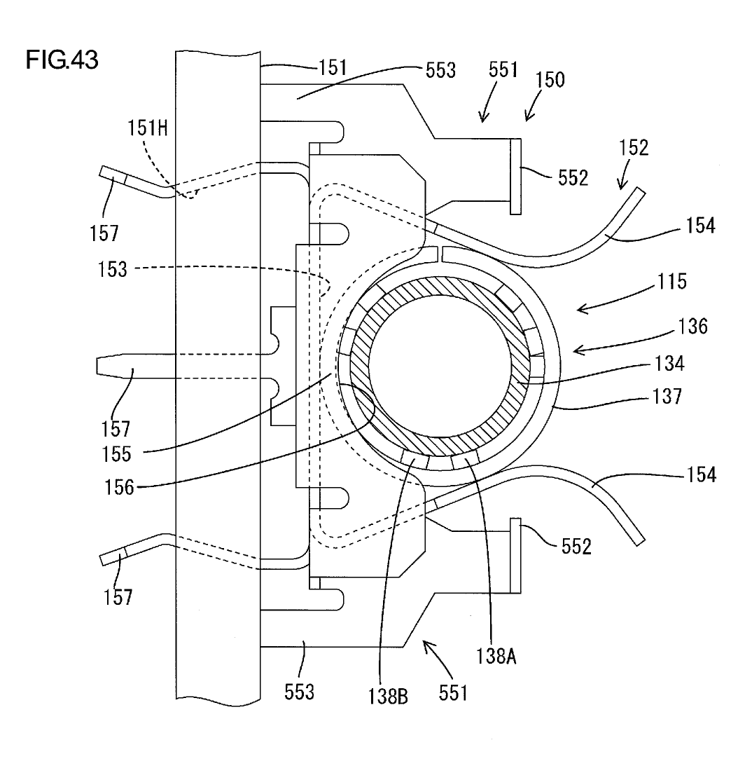

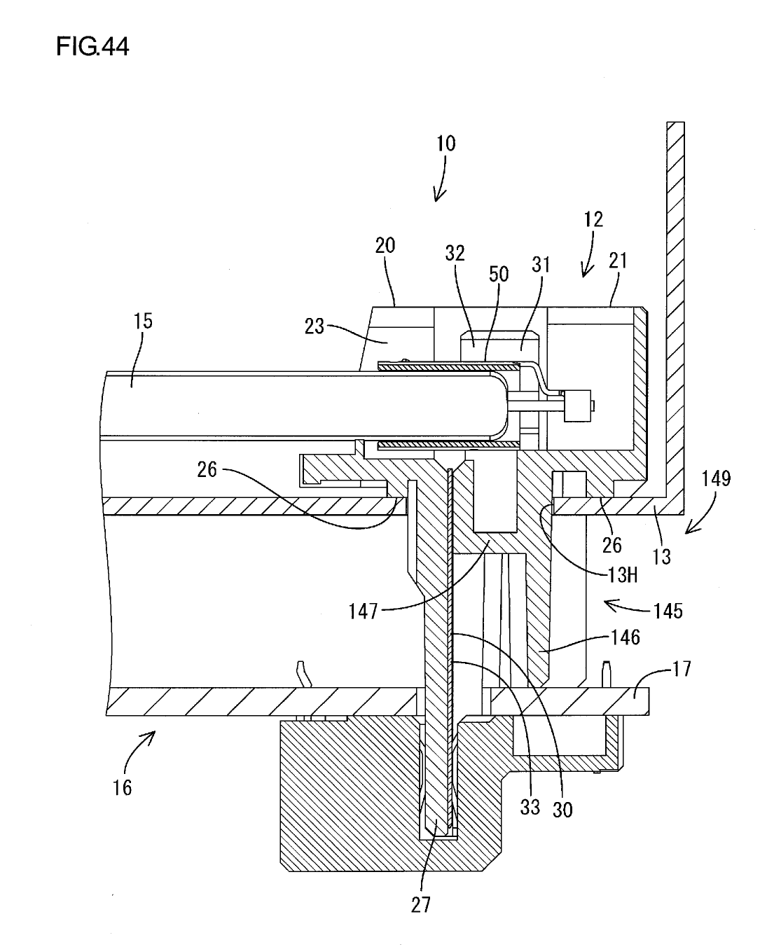

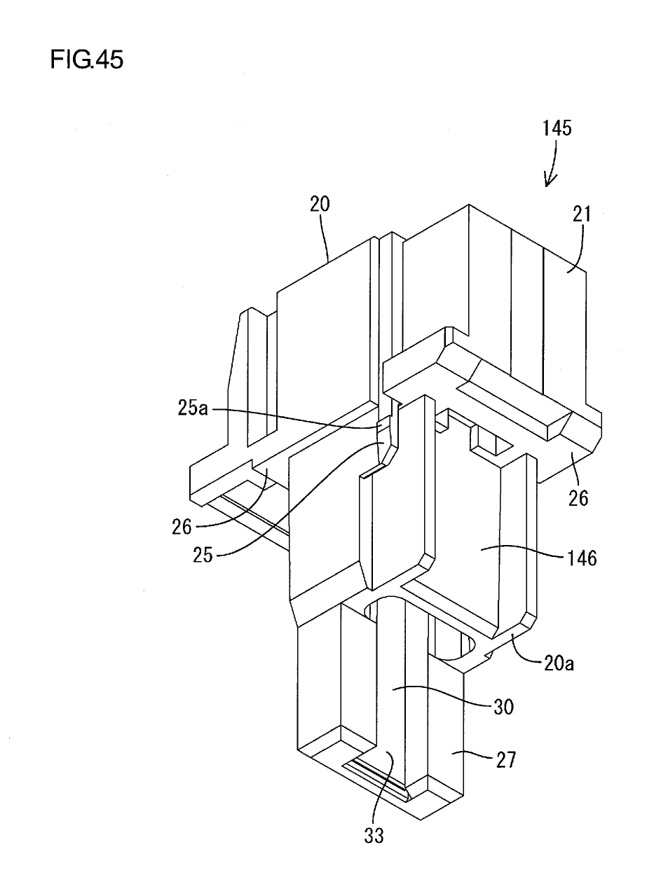

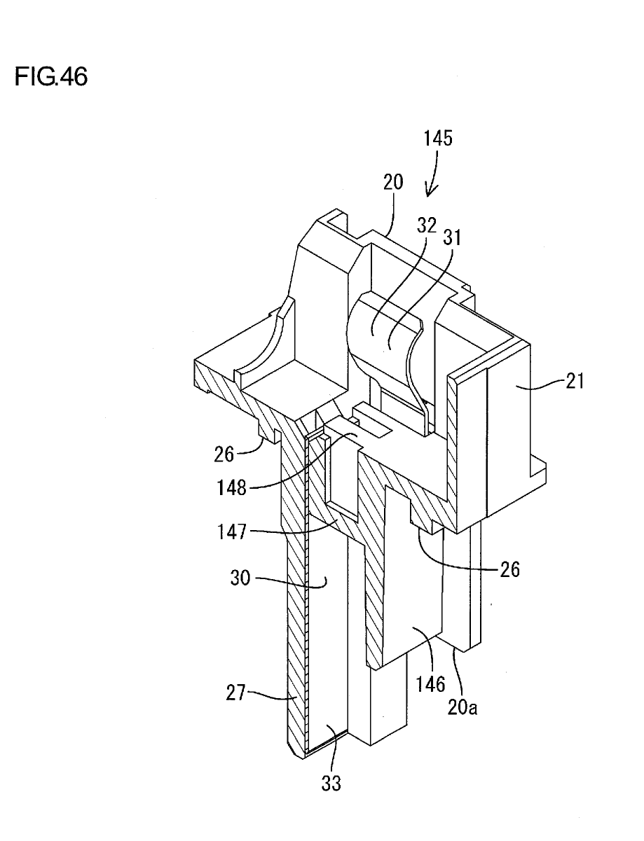

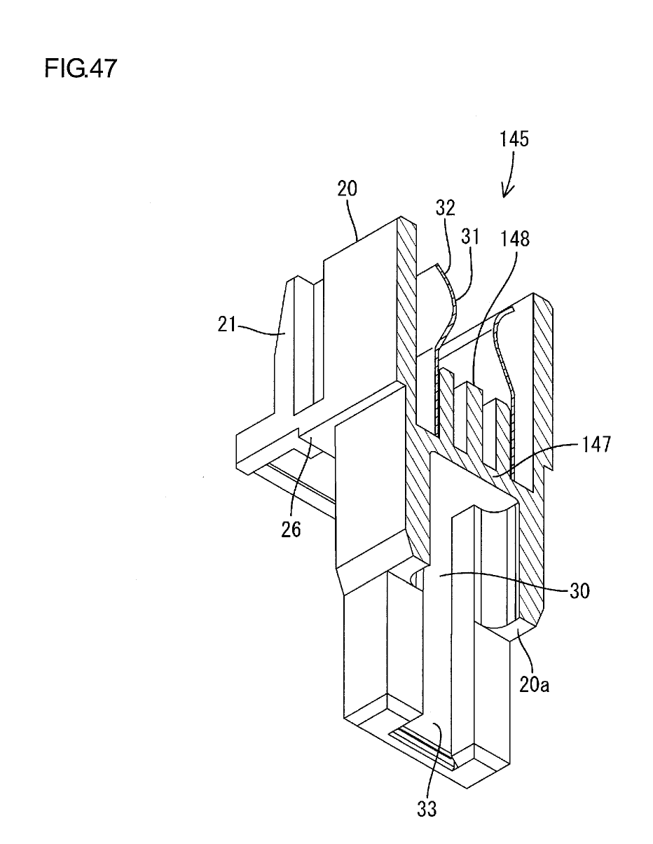

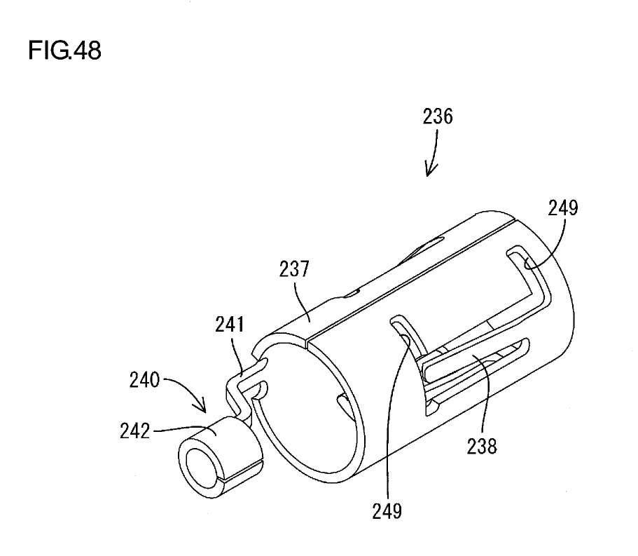

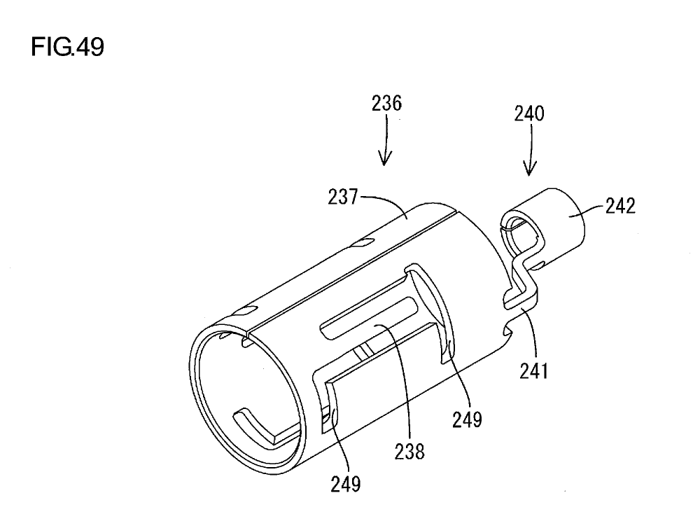

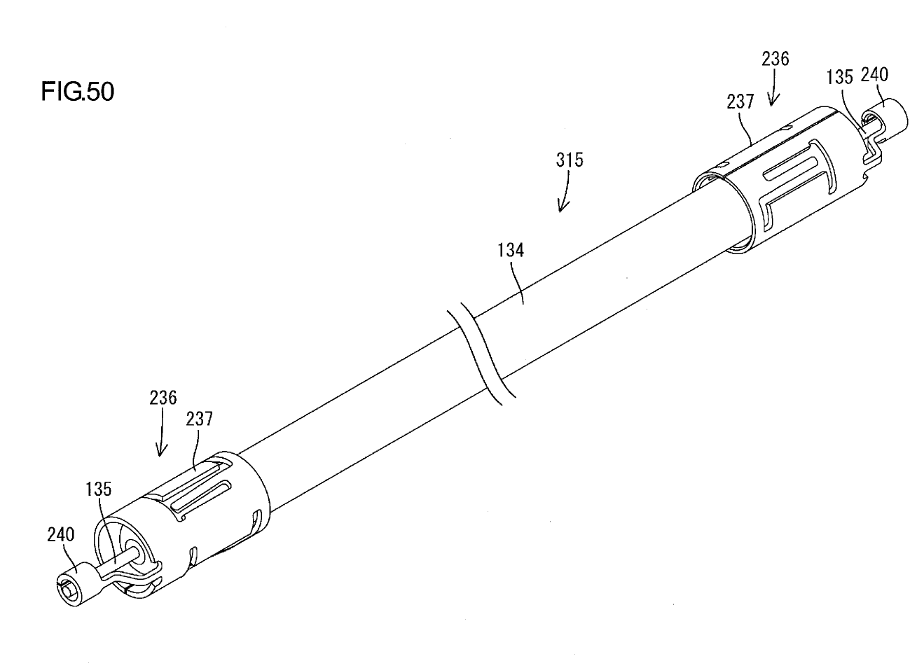

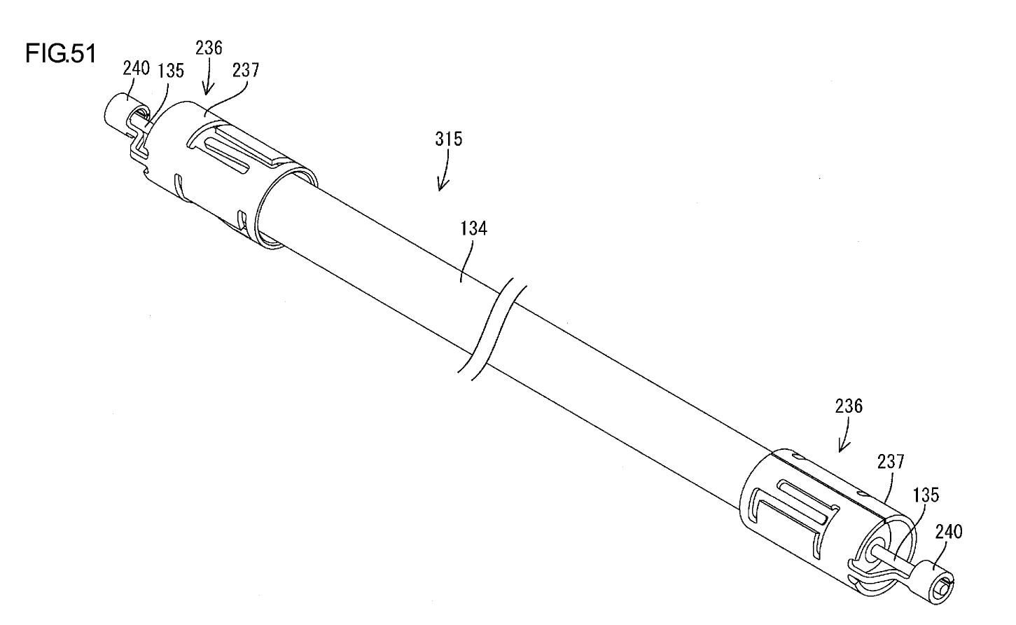

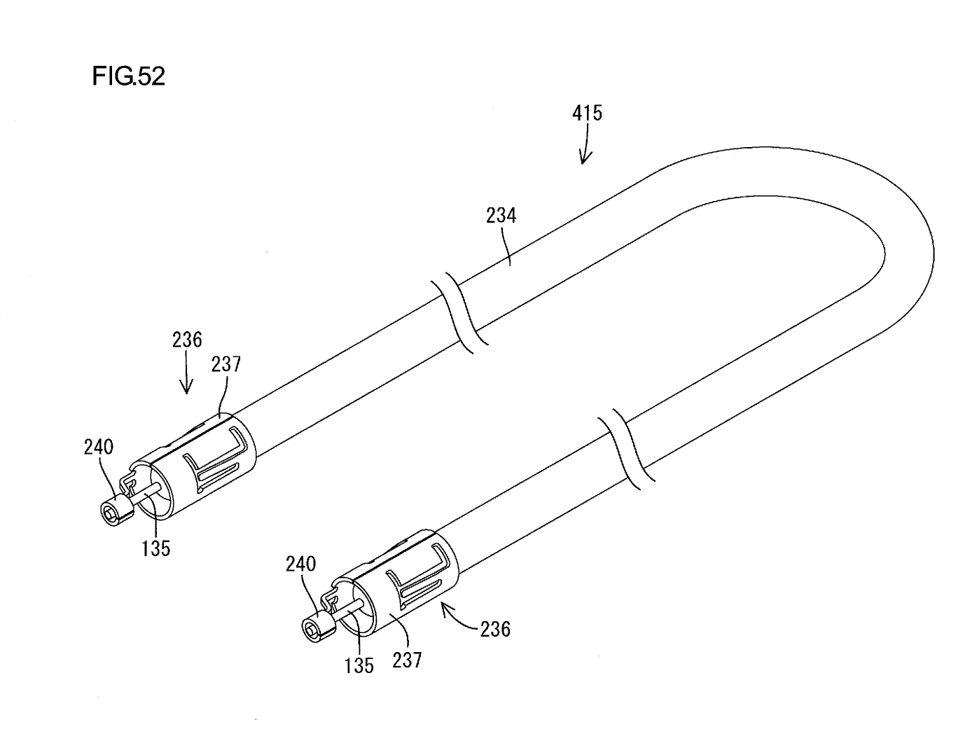

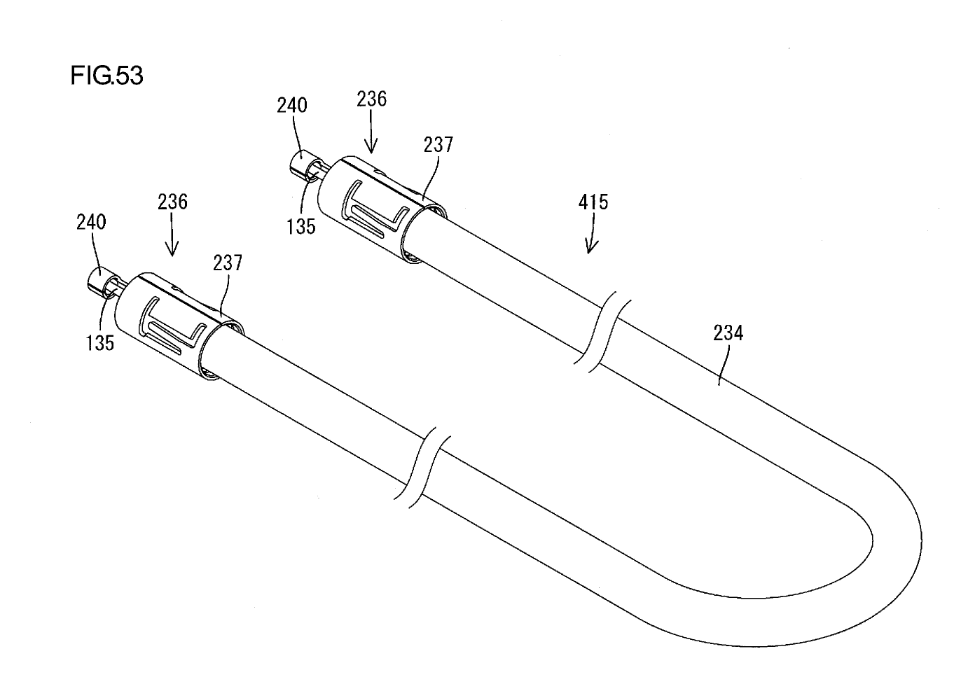

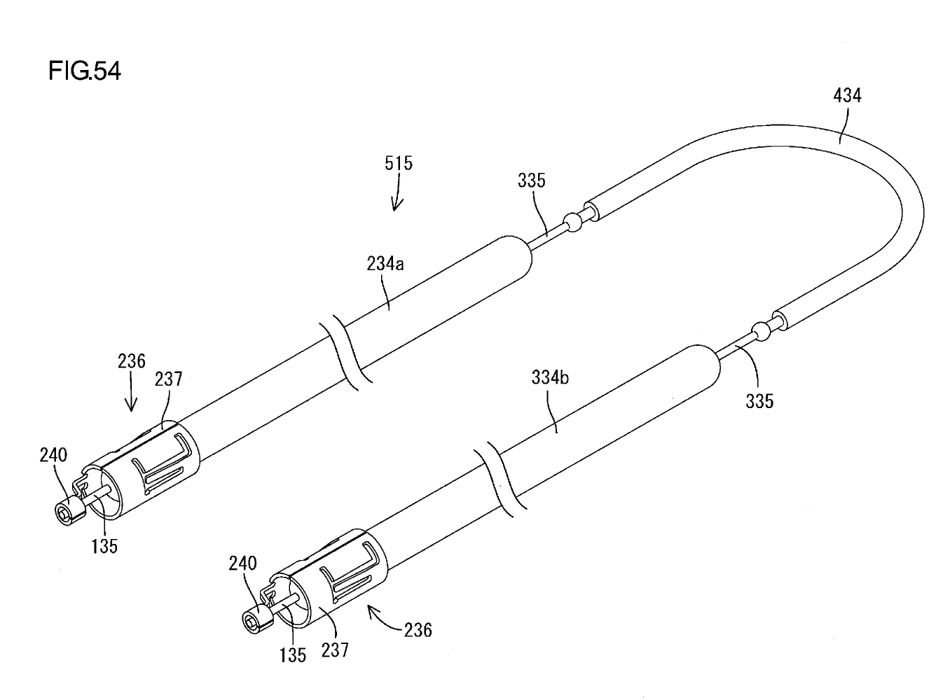

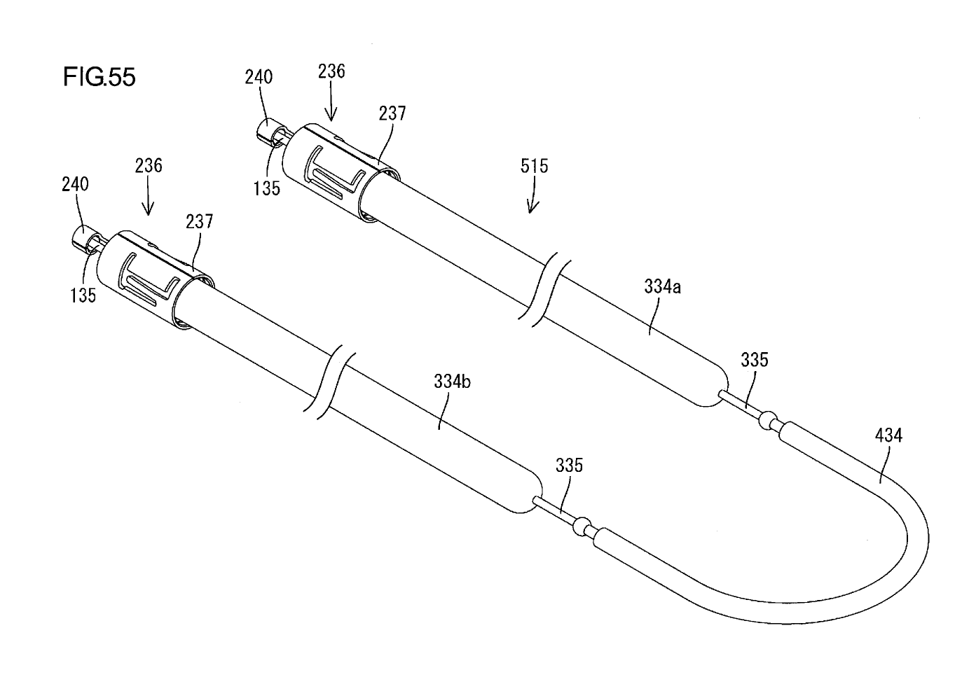

### BRIEF DESCRIPTION OF THE DRAWINGS

[FIG. 1] is an exploded perspective view illustrating a general construction of a television receiver according to the first embodiment;

[FIG. 2] is a horizontal sectional view of a display device;

[FIG. 3] is a perspective view illustrating a chassis with relay connectors, discharge tubes and power supply boards mounted thereinto;

[FIG. 4] is a rear view illustrating chassis with the power supply boards mounted thereto;

[FIG. 5] is a horizontal sectional view illustrating an on-board connector mounted to a lamp unit;

[FIG. 6] is a perspective view of the relay connector;

[FIG. 7] is a perspective view of the relay connector;

[FIG. 8] is a perspective view of the relay connector;

[FIG. 9] is a cross-sectional view illustrating an assembly structure of the relay connector and the chassis;

[FIG. 10] is a rear view of the relay connector;

[FIG. 11] is a perspective view of the discharge tube;

[FIG. 12] is a rear view of a lighting device;

[FIG. 13] is an enlarged partial view of the lighting device;

[FIG. 14] is a perspective view of the on-board connector;

[FIG. 15] is a front view of the on-board connector;

[FIG. 16] is a front view illustrating the on-board connector with the relay connector fitted thereto;

[FIG. 17] is a horizontal sectional view of the on-board connector;

[FIG. 18] is a cross-sectional view illustrating an assembly structure of a relay connector and the chassis according to the second embodiment;

[FIG. 19] is a perspective view of a relay connector according to the third embodiment;

[FIG. 20] is a side view of the relay connector according to the third embodiment;

[FIG. 21] is a front perspective view of a lighting device according to the fourth embodiment;

[FIG. 22] is a front view of the lighting device;

[FIG. 23] is a perspective view of relay connectors;

[FIG. 24] is an enlarged partial view illustrating a connection structure of the relay connector and the discharge tube;

[FIG. 25] is a side view of the relay connector;

[FIG. 26] is a cross-sectional view illustrating a condition that a ferrule of the discharge tube can be held by the stopper;

[FIG. 27] is a cross-sectional view illustrating a connection structure of the relay connector and the power supply board;

[FIG. 28] is a perspective view of the discharge tube;

[FIG. 29] is a rear view of the ferrule;

[FIG. 30] is a plan view of the ferrule;

[FIG. 31] is a side view of the ferrule;

[FIG. 32] is a rear perspective view of the lighting device according to the fourth embodiment;

[FIG. 33] is a front view of a lighting device according to the fifth embodiment;

[FIG. 34] is a front view of the lighting device without the discharge tubes;

[FIG. 35] is a rear view of the lighting device;

[FIG. 36] is a perspective view of a ground member;

[FIG. 37] is a perspective view of a ground terminal;

[FIG. 38] is a cross-sectional view illustrating a condition that a ferrule of the discharge tube can be held by the stopper;

[FIG. 39] is an enlarged partial view illustrating a connection structure of the ground terminal and the discharge tube;

[FIG. 40] is a perspective view of a modification of the ferrule;

[FIG. 41] is a side view of FIG. 40;

[FIG. 42] is a perspective view of a ground terminal;

[FIG. 43] is a cross-sectional view illustrating a connection structure of the ground terminal in FIG. 42 and the ferrule;

[FIG. 44] is a horizontal sectional view illustrating a relay connector mounted to a lamp unit according to the sixth embodiment;

[FIG. 45] is a perspective view of the relay connector according to the sixth embodiment;

[FIG. 46] is a perspective view of a part of the relay connector according to the sixth embodiment;

[FIG. 47] is a perspective view of a part of the relay connector according to the sixth embodiment;

[FIG. 48] is a front perspective view of a ferrule according to the seventh embodiment;

[FIG. 49] is a rear perspective view of a ferrule according to the seventh embodiment;

[FIG. 50] is the first perspective view illustrating an example of the lamp with ferrules according to the seventh embodiment;

[FIG. 51] is the second perspective view of the lamp in FIG. 50;

[FIG. 52] is the first perspective view of a modification of the lamp with ferrules according to the seventh embodiment;

[FIG. 53] is the second perspective view of the lamp in FIG. 52;

[FIG. 54] is the first perspective view of a different modification of the lamp with ferrules according to the seventh embodiment; and

[FIG. 55] the second perspective view of the lamp in FIG. 54.

### BEST MODE FOR CARRYING OUT THE INVENTION

### First Embodiment

The first embodiment of the present invention will be explained with reference to FIGS. 1 to 17.

[Brief Description of Display Device]

FIG. 1 is an exploded perspective view illustrating a general construction of a television receiver TV. The television receiver TV includes the display device D, front and rear cabinets Ca, Cb that house the display device D therebetween, a power source P, which is different from a later described power supply board 16 (a power source that is an element of the present invention), a tuner T and a stand S. The display device D has a landscape rectangular overall shape, and includes a display panel 11 and a lighting device 10 illustrated in FIG. 2. It is so-called a liquid crystal display panel. The display panel 11 is arranged in front of the lighting device 10. The lighting device 10 functions as a backlight and illuminates the display panel 11 from the rear. FIG. 2 illustrates the display device 10 only schematically and thus shapes of the relay connectors 14, the on-board connectors 18 and the other parts may look different from those in other drawings.

The display panel 11 has a known configuration in which liquid crystal is sealed in a gap between a transparent TFT substrate and a transparent CF substrate. On the TFT substrate, TFTs (Thin Film Transistors), which are used as switching components, connected to source lines and gate lines that are perpendicular to each other and pixel electrodes connected to the TFTs are provided. On the CF substrate, color filter having color sections of three primary colors of red (R), green (G) and blue (B) arranged in a matrix and counter electrodes are provided.

[Brief Description of Lighting Device 10]

As illustrated in FIGS. 2 to 4, the lighting device 10 includes a lamp unit 12 and power supply boards 16 (a power source that is an element of the present invention). The lamp unit 12 includes a metal chassis 13, a plurality of discharge tubes 15 and a plurality of relay connectors 14. The chassis 13 has a landscape rectangular plate-like overall shape and functions as a lamp housing. The discharge tubes 15 in a horizontal position parallel to each other are arranged one above the other in the chassis 13 on the front side. The relay connectors 14 are arranged one above the other and along the right and left side edges of the chassis 13 so as to correspond to the discharge tubes 15. The power supply boards 16 are disposed on the rear side of the chassis 13 and supply power to the discharge tubes 15 via the relay connectors 14. The chassis 13 has a plurality of mounting holes 13H having a substantially rectangular shape (see FIGS. 5, 12 and 13, for example). The mounting holes 13H are through holes that run through the chassis 13 from the front to the rear formed in locations at the same vertical positions as the respective discharge tubes 15 so as to correspond to ends of the discharge tubes 15. They are formed one above the other. The relay connectors 14 are mounted in the respective mounting holes 13H while running through to the other side.

[Relay Connector 14]

As illustrated in FIGS. 5 to 8 and 10, each relay connector 14 includes a synthetic resin holder 20 and a metal relay connector 30 housed in the holder 20.

The holder 20 includes a box portion 21 having a block-like overall shape, and a wall portion 27 that protrudes from the back of the box portion 21 toward further back. Elastic stoppers 25 provided as a pair in a cantilever structure extend along outer surfaces (top and bottom surfaces) of the box portion 21 of the holder 20, respectively, toward the rear (in the same direction as amounting direction of the relay connector 14 into the chassis 13). Each elastic stopper 25 has a substantially right triangular prism-like retaining protrusion 25a that extends in a direction opposite to the box portion 21. Elongated rib-like free-movement restricting portions 24 are formed on the top and the bottom surfaces of the box portion 21, respectively, along the elastic stoppers 25 (i.e., parallel to the elastic stoppers 25). A longitudinal side (along a direction parallel to the insertion direction of the relay connector 14 into the chassis 13) of area in which each free-movement restricting portion 24 is formed is substantially the same as that of area in which each elastic stopper 25 is formed. On a tip end side of the free-movement restricting portions 24 (on a front end side of the mounting direction of the relay connector 14 to the circuit board 17), a contact surface (insertion restriction portion) 20a that comes into contact with the circuit board 17 is formed. The contact surface 20a restricts a tip of the relay terminal 30 or the wall portion 27 from coming into contact with a back wall of a fitting recess 63. A rear surface of the box portion 21 includes a pair of stop surfaces 26, a part of which is located on the right side of the wall portion 27 and the other part of which is located on the left side of the wall portion 27. This pair of the stop surfaces 26 is provided parallel to the chassis 13 and on the right side and the left side of the elastic stoppers 25.

The box portion 21 includes a holding area 23 (a discharge tube holding portion that is an element of the present invention) that opens from the front to the right side (on a side opposite from a side edge side of the chassis 13). The font opening of the holding area 23 is a receiving opening 23a for fitting the end (ferrule 50) of the discharge tube 15 into the holding area 23 from the front. The side opening is an escape opening 23b configured to avoid interference to the glass tube 40 that could occur when the end of the discharge tube 15 is inserted in the holding area 23. A displacement restricting portion 22 projects inward from the opening edge of the escape opening 23b. A vertical size of gap in the displacement restricting portion 22 is smaller than an inner diameter of the body 51 of the ferrule 50. The box portion 21 further includes a projecting portion 28 that projects from a side surface having an opening edge of the escape opening 23b in a direction parallel to the chassis 13. The projecting portion 28 is formed so as to separate between the escape opening 23b side and the front side of the chassis 13. Surfaces of the projecting portion 28 that face the chassis 13 are the stop surface 26. The projecting portion 28 includes a hollow portion that is formed by carving out a surface that faces the chassis 13 (i.e., the rear surface).

The relay terminal 30 is held by the holder 20. The relay terminal 30 is prepared by bending a metal plate punched in a predetermined shape. It includes a discharge tube connecting portion 31 and a board connecting portion 33. The discharge tube connecting portion 31 includes upper and lower elastic clipping parts 32 that are pieces of plates formed into a substantially arch shape and provided as a pair. The board connecting portion 33 has a plate-like shape and projects toward the rear. Holding members 34 that extend from the upper and the lower edges of the board connecting portion 33 at a right angle and at the end are provided as a pair. The elastic clipping parts 32 protrude from the ends of the holding members 34 toward the front. The elastic clipping parts 32 are held in the holding area 23. The board connecting portion 33 comes out of the holder 20 through the back surface of the box portion 21. It extends toward the rear along the wall portion 27. Rib-like holding portions 27a are formed along the upper and the lower edges of the wall portion 27, respectively, provided as a pair. The board connecting portion 33 is fixed to the wall portion 27 by fitting the upper and the lower edges thereof in grooves of the rib-like holding portions 27a. The wall portion 27 and the board connecting portion 33 extend from the box portion 21 in a direction perpendicular to the chassis 13 (in the same direction as the mounting direction of the relay connector 14 into the chassis 13).

As illustrated in FIG. 9, to mount the relay connector 14 to the chassis 13, the wall portion 27 of the holder 20 is inserted into the mounting hole 13H from the front side of the chassis 13 until the stop surface 26 comes into contact with an edge of the mounting hole 13H in the chassis 13 on the front side. During the insertion, the retaining protrusions 25a of the elastic stoppers 25 are brought into contact with the edge of the mounting holes 13H and the elastic stoppers 25 are elastically bent toward the box portion 21. When the stop surfaces 26 come into contact with the front of the chassis 13 and the retaining protrusions 25a passes through the mounting hole 13H, elastic restoring of the elastic stoppers 25 occurs. As a result, the retaining protrusions 25a are held by the edge of the mounting hole 13H on the rear of the chassis 13. Namely, the chassis 13 is sandwiched by the stop surfaces and the retaining protrusion 25a from the front and the rear. As a result, the holder 20 is fixed to the chassis 13 while movement in the mounting direction (a direction in which the holder 20 passes through the mounting hole 13H) is restricted. The relay connector 14 is mounted to the chassis 13.

When the relay connector 14 is mounted to the chassis 13, the box portion 21, which is an front end portion of the holder 20, projects (or is exposed) on the front side of the chassis 13. Moreover, the wall portion 27, which is a rear end portion of the holder 20, projects (or is exposed) on the back side of the chassis 13. The elastic stoppers 25 are elastically bendable toward the respective outer surfaces of the holder 20 (i.e., in the vertical direction) and thus relative movement of the holder 20 to the chassis 13 (the mounting hole 13H) may occur while the elastic stoppers 25 are being elastically bent. However, in this embodiment, the free-movement restricting portions 24 provided on the outer surfaces where the elastic stoppers 25 are also provided come into contact with the edges of the mounting hole 13H. Therefore, the relative movement of the holder 20 to the chassis 13 in the vertical direction is restricted.

[Discharge Tube 15]

Each discharge tube 15 is a cold cathode tube. As illustrated in FIG. 11, it includes a glass tube 40, outer leads 42 and ferrules 50. The glass tube 40 has an elongated overall shape with a round cross section. The outer leads 42 project from respective ends of the glass tube 40 concentrically with the glass tube 40 and linearly. They have an elongated shape with a round cross section. The ferrules 50 are attached to the respective ends of the glass tube 40. Each of them is provided as a single part prepared by bending or hammering a gold plated metal plate (e.g., a copper alloy plate) punched into a predetermined shape. It includes a body 51 having a substantially cylindrical overall shape and a conductive part 57 that extends from the body 51 and tilts inward. The body 51 is fitted to a periphery of the end of the glass tube 40 and the conductive part 57 is connected to the outer lead 42.

Each discharge tube 15 is mounted to the relay connectors 14. To mount it, the discharge tube 15 is held in a horizontal position and brought closer to the front of the chassis 13. Then, the ends of the glass tube 40 and the ferrules 50 are fitted in the holding areas 23 of the relay connectors 14 from the front side. A mounting direction of the discharge tube 15 to the relay connectors 14 is substantially perpendicular to the front surface of the chassis 13. During the insertion of the discharge tube 15 into the holding areas 23, the elastic clipping parts 32 are elastically bent such that they are pushed outward and elastically hold the bodies 51 of the ferrules 50. As a result, the ends of the discharge tube 15 are held to the discharge tube connecting portions 31 and mounted to the chassis 13 via the relay terminal 30 and the holders 20 that are mounding bodies of the relay terminals 30.

When the discharge tube 15 is mounted to the relay connectors 14, a weight of the discharge tube 15 only affects the chassis 13 via the relay connectors 14. Namely, the weight of the discharge tube 15 does not affect the outer leads 42 as a load. Further, the elastic clipping parts 32 are in contact with the bodies 51 while elastically sandwiching the bodies 51. With this configuration, the outer leads 42 can be connected so as to be electrically connectable to the relay terminals 30 via the ferrules 50. The ferrules 50 that are fitted onto the ends of the discharge tube 15 are inserted in the holding areas 23. The displacement restricting portions 22, a width of which is smaller than an inner diameter of the ferrules 50, are formed in the escape openings 23b of the holding areas 23. When one end of the discharge tube 15 move together with the ferrule 50 in the axial direction of the discharge tube 15 in which the end comes out of the holding area 23, the ferrule 50 hits the displacement restricting portion 22. Therefore, the movement of the discharge tube 15 is restricted. Further, the projecting portion 28 projects from the outer surface of each holder 20 that is perpendicular to a plate surface of the chassis 13 and has the escape opening 23b of the holding area 23 along the plate surface of the chassis 13 in a space between the chassis 13 and the escape opening 23b. Therefore, a long creeping distance is provided between an inside of the holding area 23 and the front of the chassis 13 and thus a leakage from the discharge tube 15 inside the holding area 23 to chassis 13 outside the holder 20 is less likely to occur.

[Brief Description of Power Supply Board 16]

As illustrated in FIGS. 4 and 5, each power supply board 16 includes the circuit board 17, electronic components 19 mounted on the rear surface of the circuit board 17 and a plurality of on-board connectors 18 mounted on the rear surface of the circuit board 17. An electronic circuit is formed on a rear surface (i.e., a surface opposite from the chassis 13 side) of the circuit board 17.

The circuit board 17 has a portrait rectangular overall shape. A paper phenolic copper clad laminated board (referred to as a paper phenol) is used for the circuit board 17. A plurality of fitting holes 17H are formed in the circuit board 17 so as to run through from the front side to the rear side. The fitting holes 17H are provided along the right and left edge area of the circuit board 17 from top to bottom so as to correspond to the reley terminals 30 (the relay connectors 14).

As illustrated in FIGS. 14 to 17, each on-board connector 18 includes a synthetic resin housing 60 and a metal output terminal 70 housed entirely in the housing 60. A plurality of them are arranged along the right and left edge areas of the circuit board 17 so as to correspond to the respective fitting holes 17H. A fitting recess 63 is provided inside each housing 60. It has a portrait rectangular opening in the outer surface of the housing 60 (a surface that faces the circuit board 17). The fitting recess 63 is formed in a location and a size so as to substantially correspond to the fitting hole 17H. The relay connector 14 is fitted in the fitting recess 63.

The output terminal 70 is prepared by bending a metal plate punched into a predetermined shape. It includes a base end portion 71, a supporting section 74, a flexible portion 72 and a connecting portion 73. It is mounted to the inside of the housing 60 from the surface side that faces the circuit board 17. The base end portion 71 is formed in a plate-like shape and press fixed to the housing 60. It is electrically connected to the circuit board 17. The base end portion 71 is fixed to the circuit board 17 and thus the on-board connector 18 is integrated to the circuit board 17. The supporting section 74 has an elongated overall shape and extends from the base end portion 71 at a substantially right angle. The flexible portion 72 has an elongated overall shape and extends from a distal end of the supporting section 74 at a substantially right angle. It is deformable so as to make an acute angle or an obtuse angle with the supporting section 74. The connecting portion 73 has an overall shape of substantially narrow horseshoe with a smaller gap between ends thereof. The connecting portion 73 includes the first half section 73a and the second half section 73b. The first half section 73a extends from a distal end of the flexible portion 72 and turns around to a direction away from the circuit board 17. The second half section 73b extends from a distal end of the first section 73a and turns around to a direction toward the circuit board 17. The parts of the first half section 73a and the second half section 73b at which the gap therebetween is small are located in the fitting recess 63.

The power supply board 16 is held close to the rear surface of the chassis 13 and connected such that the circuit board 17 is set parallel to the chassis 13. A mounting direction of the on-board connectors 18 to the relay connector 14 is opposite from the mounting direction of the discharge tube 15 to the relay connectors 14. Namely, the mounting direction of the discharge tube 15 and that of the on-board connectors 18 to the relay connectors 14 are parallel to each other. During the assembly, the wall portion 27 of the relay connector 14 and the board connecting portion 33 that is provided along the wall portion 27 are inserted into the fitting recess 63 of the on-board connector 18 through the fitting hole 17H of the circuit board 17. As illustrated in FIGS. 5 and 16, they squeeze between the first half section 73a and the second half section 73b. As a result, the wall portion 27 comes into contact with the first half section 73a while the board connecting portion 33 comes into contact with the second half section 73b. The connecting portion 73 elastically deforms such that the first half section 73a and the second half section 73b are separated further apart. As a result, the relay connector 14 is fitted to the on-board connector 18 and the relay terminal 30 becomes electrically connectable to the output terminal 70. The power supply board 16 and the discharge tube 15 are connected with each other via the relay connector 14 and power can be supplied from the power supply board to the discharge tube 15. After the on-board connector 18 is set in a proper fitting condition with respect to the relay connectors 14, the power supply board 16 is fixed to the chassis 13 with screws.

When the power supply board 16 is connected to the relay connectors 14, the board connecting portion 33 elastically comes into contact with the half section 73a, which is one of the two half sections 73a, 73b included in the connecting portion 73, on a free-end side that is opposite from the flexible portion 72. Further, the wall portion 27 elastically comes into contact with the half section 73b, which is one of the two half sections 73a, 73b included in the connecting portion 73, on a flexible portion 72 side. When the board connecting portion 33 of the relay terminal 30 is shifted toward the flexible portion 72 side with respect to the output terminal 70, all sections of the connecting portion 73 move toward the flexible portion 72 side together with the board connecting portion 33 and the wall portion 27. Therefore, the connection between the board connecting portion 33 and the half section 73b on the free-end side is maintained. When the board connecting portion 33 is shifted toward the free-end side, which is the other side to the flexible portion 72 side, with respect to the output terminal 70, the section 73b of the connecting portion 73 on the free-end side is pushed by the board connecting portion 33 and moves toward the free-end side. Therefore, the connection between the board connecting portion 33 and the section 73b on the free-end side is maintained.

A thermal expansion coefficient of the circuit board 17 that is a mounting body of the output terminals 70 is different from that of the chassis 13 that is a mounting body of the relay terminals 30. When a plurality of the output terminals 70 and a plurality of the relay terminals 30 are arranged, the positions of the output terminals 70 and the relay terminals 30 may be shifted from each other in the arrangement direction of the output terminals 70 and the relay terminals 30 due to the difference in the thermal expansion coefficient and the like.

In this embodiment, each output terminal 70 includes the elongated connecting portion 73 that extends in a direction substantially perpendicular to the arrangement direction. Moreover, each relay terminal 30 includes the plate-like shape board connecting portion 33 that is wider than the connecting portion 73 and parallel to the arrangement direction. This wide board connecting portion 33 is brought into contact with the elongated connecting portion 73. Since the board connecting portion 33 has a large width in the arrangement direction, the connection between the board connecting portion 33 and the connecting portion 73 is maintained even when the relay terminal 30 and the output terminal 70 become out of alignment in the arrangement direction.

Further, the circuit board 17 has the fitting holes 17H that are through holes. Therefore, the on-board connectors 18 can be arranged on the rear surface of the circuit board 17 that is located on the opposite side from the chassis 13 side.

Still further, each relay connector 30 is fitted in the fitting recess 63 with a clearance between itself and the inner surfaces of the fitting recess 63. This clearance allows the position shift of the relay connector 30 within the fitting recess 63. For example, it is fitted in the fitting recess 63 such that the position shift in the vertical direction in FIG. 5, that is, an insertion direction of the relay connector 30 to the fitting recess 63 is allowed. When the position of the relay connector 30 is changed in the insertion direction, the connection with the output terminal 70 is maintained. Specifically, as illustrated in FIG. 5, a contact area margin that projects from the contact area between the board connecting portion 33 and the connecting portion 73 toward the back wall of the fitting recess 63 is larger than an allowable position shift area in the insertion direction. Therefore, the connection between the relay terminal 30 and the output terminal 70 is maintained. Furthermore, a length of the wall portion 27 is determined such that a tip of the relay terminal 30 will not contact the rear wall of the fitting recess 63 when the relay terminal 30 is inserted in the fitting recess 63.

Each relay connector 14 of the present embodiment includes the holder 20 having insulation properties and the relay terminal 30. The holder 20 is mounted to the chassis 13. The relay terminal 30 is electrically connectable to the discharge tube 15 and the power supply board 16, and mounted to the holder 20. Therefore, the relay terminal 30 does not directly come into contact with the chassis 13 and thus the chassis 13 can be made of a metal.

The holder 20 is passed through the mounting hole 13H of the chassis 13. The elastic stoppers 25 that are elastically flexible and the stop surfaces 26 are provided on the outer surfaces of the holder 20. The elastic stoppers 25 extend in a direction substantially parallel to a direction in which the holder 20 passes through the mounting hole 13H. The stop surfaces 26 are formed in a direction substantially perpendicular to the direction in which the holder 20 passes through the mounting hole 13H. By sandwiching the chassis 13 with the elastic stoppers 25 and the stop surfaces 26, the holder is fixed to the chassis 13. Therefore, the relay connector 14 is mounted to the chassis 13 only by inserting the holder 20 into the mounting hole 13H.

The discharge tubes 15 are electrically connected to the discharge tube connecting portions 31 in the holding areas 23. Therefore, connections between the discharge tubes 15 and the relay terminals 30 are protected from contact with foreign substances.

Further, the board connecting portion 33 is provided along the wall portion 27. Therefore, the board connecting portion 33 are protected from deformation and the like due to contact with foreign substances.

Still further, each holder 20 includes the holding area 23 (the discharge tube fitting portion) and the wall portion 27 (power supply fitting portion). The holding area 23 allows the discharge tube 15 to enter from the direction substantially perpendicular to the plate surface of the chassis 13. The wall portion 27 allows the on-board connector 18 of the power supply board 16 to be fitted from the direction substantially perpendicular to the plate surface of the chassis 13. With this configuration, the mounting direction of the discharge tube 15 to the relay connector 14 and that of the power supply board 16 to the relay connector 14 are both substantially perpendicular to the plate surface of the chassis 13. Therefore, the discharge tube 15 and the power supply board 16 can be arranged in a stacking structure.

### Second Embodiment

Next, the second embodiment of the present invention will be explained with reference to FIG. 18. In the second embodiment, the shape of the retaining protrusion 25a of the elastic stopper 25 is different from the first embodiment. Other configurations are the same as the first embodiment. The same parts as those in the first embodiment are indicated by the same symbols. The same structures, functions and effects will not be explained.

In the second embodiment, a contact surface of the retaining protrusion 25a of each elastic stopper 25 with an edge of the mounting hole 13H is configured to be a sloped surface 25b that is sloped with respect to a thickness direction of the chassis 13 (i.e., the mounting direction of the relay connector 14 to the chassis 13). Therefore, the chassis 13 is properly sandwiched between the elastic stoppers 25 and the stop surfaces 26 even when the thickness of the chassis 13 varies.

### Third Embodiment

Next, the third embodiment of the present invention will be explained with reference to FIGS. 19 and 20. In the third embodiment, each relay connector 14 of the first embodiment is modified such that each holder 20 has tapered guide portions 29a. The tapered guide portions 29a project forward from edges of the receiving opening 23a, which is an opening for receiving the discharge tube 15. They are provided on the top and bottom of the holding area 23 as a pair. Each tapered guide portion 29 has a guide surface that is sloped with respect to the mounting direction of the discharge tube 15. The guide surfaces are provided on either side of the discharge tube connecting portion 31.

By providing the tapered guide portions 29, the discharge tube 15 is guided into the holding area 23 during assembly. To mount the discharge tube 15 held by an arm of an automated machine (not shown) to the relay connector 14, the arm should have surfaces responding to the guide surfaces of the tapered guide portions and having the same slope angle with the guide surfaces. By providing such surfaces, the discharge tube 15 is properly positioned with respect to the discharge tube connecting portion 31 in the holding area 23.

### Fourth Embodiment

Next, the fourth embodiment of the present invention will be explained with reference to FIGS. 21 to 32. In the fourth embodiment, alighting device 110 having a different configuration from the first embodiment is provided. Other configurations are the same as the first embodiment. The same parts as those in the first embodiment are indicated by the same symbols. The same structures, functions and effects will not be explained.

[Brief Description of Lighting Device 110]

As illustrated in FIGS. 21 and 22, the lighting device 110 includes a lamp unit 112 and power supply boards 116. The lamp unit 112 includes a metal chassis 113, a plurality of discharge tubes 115 and a plurality of relay connectors 114. The chassis 113 has a landscape rectangular plate-like overall shape. The chassis 113 functions as a reflector plate. The discharge tubes 115 in a horizontal position parallel to each other are arranged one above the other in the chassis 13 on the front side. The relay connectors 114 are arranged one above the other and along the right and left side edges of the chassis 113 so as to correspond to the discharge tubes 115. The power supply boards 116 are disposed on the rear side of the chassis 113 and supply power to the discharge tubes 115 via the relay connectors 114.

The chassis 113 has a plurality of mounting holes 113H having a substantially rectangular shape. The mounting holes 113H are through holes that run through the chassis 113 from the front to the rear formed in locations at the same vertical positions as the respective discharge tubes 115 so as to correspond to ends of the discharge tubes 115. They are formed one above the other. The relay connectors 114 are mounted in the respective mounting holes 113H while running through to the other side.

[Relay Connector 14]

As illustrated in FIGS. 23 to 26, each relay connector 114 includes a synthetic resin holder 120 and a relay connector 131 made of a metal (e.g., stainless steel) and housed in the holder 120.

The holder 120 includes a box portion 121 having a block-like overall shape and a wall portion 122 that protrudes from the back of the box portion 121 toward further back.

The box portion 121 includes a holding area 123 that opens from front to side (a side opposite from a side of the chassis 113). A front opening of the holding area 123 is a receiving opening 124 for inserting an end of the discharge tube 115 (or a ferrule 136) from the font. A side opening is an escape opening 125 that allows the glass tube 134 is placed properly without interference when the end of the discharge tube 115 is inserted in the holding area 123. The escape opening 125 includes a stopper 126 (a displacement restricting portion that is an element of the present invention). With this stopper 126, the escape opening 125 is shaped in a substantially U shape so as to be narrowed at the end. A vertical size of the opening of the escape opening 125 having the substantially U shape is smaller than an inner diameter of a body 137 of the ferrule 136 and equal to or slightly larger than an outer diameter of the glass tube 134. A back end area of the edge of the escape opening 125 is formed as a concave portion 127. A curvature radius of the concave portion 127 is equal to or larger than a curvature radius of a periphery of the glass tube 134. Parts of the edge of the escape opening 125 that is located more to the front than the concave portion 127 are guide portions 28 provided as a pair.

The box portion 121 further includes a projecting portion 129 that projects from a side surface having an opening edge of the escape opening 125 in a direction parallel to the chassis 113. The projecting portion 129 is formed so as to separate the escape opening 125 from the front of the chassis 113. Top and bottom stopper protrusions 130 are provided as a pair on outer surfaces (top and bottom surfaces) of the box portion 121, respectively.

The relay terminal 131 is held inside the holder 120. The relay terminal 131 is prepared by bending a metal plate punched in a predetermined shape. It includes a pair of elastic pressing pieces 132 that are curved plates and vertically symmetric, and a board connecting portion 133 that a plate-like shape and projects toward the rear. The elastic pressing pieces 132 are housed in the holding area 123 such that they are flexible in the vertical direction in which they come away from each other. A vertical distance between the elastic pressing pieces 132 at a point more to the front than the concave portion 127 of the stopper 126 is the smallest. The smallest distance between the elastic pressing pieces 132 in the free state when the elastic pressing pieces 132 are not elastically bent is smaller than the outer diameter of the body 137 of the ferrule 136 fitted onto the discharge tube 115. On the other hand, the board connecting portion 133 projects from the back of the box portion 121 to the rear along the wall portion 122 so as to be exposed on the outside of the holder 120.

When mounting the relay connector to the chassis 113, the wall portion 122 of the holder 120 is inserted into the mounting hole 113H from the front side of the chassis 113. The outer surface of the box portion 121 is brought into contact with the edge of the mounting hole 113H on the front surface of the chassis 113. With this configuration, the chassis 113 is sandwiched by the stop surfaces 130 and the stopper protrusions 130 from front and rear. Namely, the holder 120 is fixed such that the movement in the mounting direction to the chassis 113 (the direction in which the holder 120 passes through the mounting hole 113H) is restricted, and the relay connector 114 is mounted to the chassis 113. When the relay connector 114 is mounted to the chassis 113, the box portion 121 that is a front part of the holder 120 projects (or is exposed) on the front side of the chassis 113, and the wall portion that is a rear part of the holder 120 projects (or is exposed) on the rear side of the chassis 113.

[Discharge tube 115]

As illustrated in FIG. 28, each discharge tube 115 is a cold cathode tube. It includes, a linear glass tube 134, outer leads 135 and ferrules 136. The glass tube 134 has an elongated overall shape with a circular cross section. The outer leads 135 are elongated metal pieces (made of a nickel or cobalt contained metal, for example) with a circular cross section. They project from the respective ends of the glass tube 134 coaxially with the glass tube 134 and linearly. The ferrules 136 are attached to the respective ends of the glass tube 134. Mercury is sealed in the glass tube 134. The ends of the glass tube 134 are shaped in a substantially dome shape by melting them with heat. The outer leads 135 penetrate through the dome portions.

As illustrated in FIGS. 29 to 31, each ferrule 136 is a single part prepared by bending or hammering a metal plate (e.g., made of stainless steel) punched in a predetermined shape. The ferrule 136 includes a body 137 and a conductive part 140. The body 137 has a cylindrical overall shape with a concentric circle cross section with the glass tube 134. An inner diameter of the body 137 is slightly larger than an outer diameter of the glass tube 134.

The body 137 includes three pairs of elastic holding parts 138A and 138B that are formed by cutting out parts of the body 137 so as to form slits around the elastic holding parts 138A, 138B at an equal angular interval.

The first elastic holding parts 138A of the pair of elastic holding parts 138A and 138B are cantilever parts that extend generally to the rear (specifically, slightly bent inward in the radial direction). They are elastically flexible in the radial direction with base ends (front ends) thereof as supporting points. A tip of each first elastic holding part 138A (rear end) includes a bent portion 139 that is bent outward in the radial direction. A surface of the bent portion 139 located on the outer curved side (i.e., a surface that faces inward) is a contact point that comes into contact with the periphery of the glass tube 134. An imaginary circle that connects contact points of three first elastic holding parts 138A is a circle concentric with the body 137. A diameter of the imaginary circle is smaller than the outer diameter of the glass tube 134 when the first elastic holding parts 138A are in the free state when the first elastic holding parts 138A are not elastically bent.

The second elastic holding part 138B of the pair of elastic holding parts 138A and 138B is provided adjacent to the first holding part 138A in the circumferential direction. An overall structure thereof is a cantilever piece that extends forward, that is, in an opposite direction to the first elastic part 138A (specifically, slightly bent inward in the radial direction). It is elastically flexible in the radial direction with base end (rear end) thereof as a supporting point. A tip of the second elastic holding part 138B is a contact point that comes into contact with the periphery of the glass tube 134. An imaginary circle that connects contact points of three second elastic holding parts 138B is a circle concentric with the body 137. A diameter of the imaginary circle is smaller than the outer diameter of the glass tube 134 when the second elastic holding parts 138B are in the free state when the second elastic holding parts 138B are not elastically bent.

The body 137 includes a pair of protective parts that are cantilever pieces projecting forward from a front rim. The protective parts are provided with a gap in the circumference direction so as to extend linearly from the body 137 on the same plane. A cantilever conductive part 140 is provided so as to extend from between the protective parts. Each conductive part 140 includes an elongated portion 141 that continues from the font rim of the body 137 and a drum-like portion 142 that projects from a front end (a tip) of the elongated portion 141 further to the front.

The elongated portion 141 includes a base end portion 141a, a middle section 141b and a tip section 141c. The base end portion 141a extends from the body 137 on the same plane with respect to the body 137 and parallel to the axis of the body 137. The meddle section 141b extends from a distal end of the base end portion 141a inward in the radial direction toward the axis of the body 137. The tip section 141c extends from a distal end of the middle section 141b parallel to the axis of the body 137. The drum-like portion 142 continues from a distal end of the tip section 141c. A width of the elongated portion 141 is sufficiently smaller than a length thereof. Therefore, the elongated portion 141 is elastically flexible in the radial direction of the body 137 or in a direction that crosses the radial direction (a direction that crosses a length direction of the elongated portion 141), or elastically twisted around itself as a torsion axis.

The drum-like portion 142 is provided by forming a piece extends from the distal end of the elongated portion 141 and jetties in a horizontal direction into a drum-like shape. It is positioned such that an axis thereof substantially matches the axis of the body 137. The drum-like portion 142 can change a position thereof around the axis or in the radial direction of the ferrule 136 according to the elastic deflection of the elongated portion 141.

[Mounting of the Ferrule 136 to the Glass Tube 134]

Next, a process of mounting the ferrules 136 to the glass tubes 134 will be explained.

In the process, the glass tube 134 and the ferrules 136 are held by respective holding devices (not shown) and they are brought closely to each other with the axes thereof aligned. Then, the body 137 is fitted onto the glass tube 134. As the glass tube 134 goes into the body 137, the contact points at the distal ends of three pairs of the elastic holding parts 138A, 138B are elastically brought into contact with the periphery of the glass tube 134. As the glass tube 134 goes further into the body 137, the elastic holding ports 138A, 138B rub against the peripheral surface of the glass tube 134 at the contact points. Tips of the outer leads 135 start entering inner spaces of the drum-like portions 142 after passing through the bodies 137. When the holding devices reach predetermined positions, the ferrules 135 and the glass tube 134 are positioned at proper axial locations and the entire peripheries of the tips of the outer leads 135 are surrounded by the drum-like portions 142. The tips of the outer leads 135 do not project from the front edges of the drum-like portions 142 significantly. Namely, they project slightly from the drum-like portions 142, or stay at about the same positions as the front edges of the drum-like portions 142 or within the drum-like portions 142.

Then, the drum-like portions 142 are swaged such that they are deformed to shrink in the radial direction. The swaged drum-like portions 142 and the respective outer leads 135 are fixed together by welding so as to be electrically conductive, and the ferrules 136 and the glass tube 134 are integrated. Then, the assembly is completed and the discharge tube 115 is prepared.

When the ferrules 136 are mounted to the glass tube 134, the body 137 is held concentrically with the glass tube 134 by the elastic holding force provided by three pairs of the elastic holding parts 138A, 138B. As a result, gaps (air layers) are provided between the outer surfaces of the glass tube 134 and the inner surfaces of the bodies 137 in substantially entire peripheral areas of the bodies 137.

The drum-like portion 142 can be formed in a U-shape such as a connecting portion 142a illustrated in FIGS. 40 and 41,. In this case, the U-shaped connecting portion 142a is bent around the outer lead 135 after the ferrule 136 is fitted onto the glass tube 134. As a result, the connecting portion 142a is electrically connectable to the outer lead 135. According to such a configuration in which the U-shaped connection portion is bent, the electrical connection to the outer lead 135 improves.

[Mounting of the Discharge tube 115 to the Relay Connectors 114]

The discharge tubes 115 manufactured in the above process will be mounted to the relay connectors 114. For mounting, each discharge tube 115 is held in a horizontal position and brought close to the front of the chassis 113. Then, the ends of the glass tube 134 and the ferrules 136 are fitted into the holding areas 123 of the relay connectors 114 from the front. The elastic pressing pieces 132 are elastically deflected by the bodies 137 of the ferrules 136 so as to open in the vertical direction. After the bodies 137 have passed through the smallest gaps between the elastic pressing pieces 132, the elastic pressing pieces 132 draw the bodies 137 into the back areas of the holding areas 123 with elastic restoring force thereof and the bodies 137 are brought into contact with the bottoms of the holding areas 123. Then, the mounting of the discharge tube 115 is completed.

Each mounted discharge tube 115 is held by a pair of elastic pressing pieces 132 at the ends thereof. The discharge tubes 115 are mounted to the chassis 113 via the relay terminals 131 and the holders 120 that are the mounting bodies of the relay terminals 131. With this configuration, weight of the discharge tubes 115 is only applied to the chassis 113 via the relay connectors 114. The weight of the discharge tubes 115 is not applied to the outer leads 115 as a load.

The elastic pressing pieces 132 are elastically brought into contact with the periphery of the respective bodies 137. As a result, the outer leads 135 are connected to the ferrules 136 so as to be electrically conductive. Further, each glass tube 134 is pressed against the concave portions 127 of the stoppers 126 and held by the elastic restoring force of the elastic pressing pieces 132. When viewed in the axial direction of the discharge tube 115, a part of the body 137 overlaps the stopper 126. Namely, a part of the rim of the body 137 on an opposite side from the side where the conductive part 140 is provided faces the stopper 126 in a short distance in the axial direction.

On the outer surface of each holder 120 that is perpendicular to the plate surface of the chassis 113 and has the escape opening 125 of the holding area 123, the projecting portion 129 that projects along the plate surface of the chassis 113 in a space between the chassis 113 and the escape opening 123 is formed. Therefore, a long creeping distance is provided between the inside of the holding area 123 and the front of the chassis 113 and thus a leakage from the discharge tube 115 inside the holding area 123 to chassis 113 that is outside the holder 120 is less likely to occur.

[Brief Description of the Power Supply Boards 116]

As illustrated in FIG. 32, each power supply board 116 includes a circuit board 117, electronic components 119 and a plurality of on-board connectors 118. A circuit is formed on a back surface (a surface opposite from the chassis 113) of the circuit board 117. The electronic components 119 are mounted on the back surface of the circuit board 117. The on-board connectors 118 are mounted on the back surface of the circuit board 117.

The circuit board 117 has a portrait rectangular overall shape.

A paper phenolic copper clad laminated board (referred to as a paper phenol) is used for the circuit board 117. A plurality of fitting holes 117H are formed in the circuit board 117 so as to run from the front side to the rear side. The fitting holes 117H are provided along the right and left edge areas of the circuit board 117 in a top to bottom direction so as to correspond to the reley terminals 131 (or the relay connectors 114). Each on-board connector 118 includes a synthetic resin housing and a metal (e.g., a nickel silver alloy) output terminal (not shown) housed entirely in the housing. A plurality of them are arranged along the right and left edge areas of the circuit board 117 so as to correspond to the respective fitting holes 117H. Fitting areas (not shown) that correspond to the fitting holes 117 are formed in outer surfaces of the housings and a part of each output terminal is bared in the fitting area.

The power supply board 116 is mounted close to the chassis 113 in a position that the circuit board 117 is parallel to the chassis 113. For mounting, the wall portion 122 of the relay connector 114 and the board connecting portion 133 provided along the wall portion 122 are passed through the fitting hole 117H and inserted into the fitting recess 127 of the on-board connector 118. As a result, the relay connector 114 and the on-board connector 118 are fitted together and the relay terminal 131 is connected to the output terminal so as to be conductive.

[Functions and Effects of Fourth Embodiment]

In the fourth embodiment, the ferrules 136 are stopped by the stoppers 126 while the discharge tubes 115 are held by the relay connectors 114. Therefore, the discharge tubes 115 are less likely to move in the axial direction with respect to the relay connectors 114. Namely, when force to move in the right direction is applied to the discharge tubes 115, the ferrules 136 mounted to left ends of the discharge tubes 115 are stopped at the left sides of the stoppers 126. Therefore, the movement of the discharge tubes 115 to the right is restricted. When force to move in the left direction is applied to the discharge tubes 115, the ferrules 136 mounted to right ends of the discharge tubes 115 are stopped at the right sides of the stoppers 126. Therefore, the movement of the discharge tubes 115 to the left is restricted. The movement of the discharge tubes 115 to right and left along the axes thereof is restricted. Thus, the tips of the outer leads 135 are less likely to hit the wall portions 122 that are located on opposite side from the escape openings 125 in the holding areas 123.

The stoppers 126 hold the rims of the ferrules 136 and thus holes for fixing the stoppers 126 to the ferrules 136 are not required. Therefore, processing cost can be reduced and strength of the ferrules 136 is less likely to be reduced.

If each stopper 126 holds a rim of the ferrule 136 located on the conductive part 140 side, the conductive part 140 that extends from the rim of the ferrule 136 may become an obstacle to fitting the rim of the ferrule 136 to the stopper 126 depending on an orientation of the ferrule 136 in the peripheral direction. In the fourth embodiment, the stopper 126 holds a part of the rim on the opposite side from where the conductive part 140 is located. Therefore, the conductive part 140 is less likely to become an obstacle to fitting of the rim of the ferrule 136 to the stopper 126. Thus, the rim of the ferrule 136 is properly fitted to the stopper 126.

The conductive part 140 includes the drum-like portion 142 that surrounds the periphery of the outer lead 135 all around and thus the conductive part 140 does not come off of the outer lead 135. When the drum-like portion 142 is press fitted, the drum-like portion 142 is not slipped from the outer lead 135. Therefore, the conductive part 140 and the outer lead 135 are properly connected.

A fitting area in which the ferrule 136 and the stopper 126 are in contact has a height about ½ of the difference between the outer radius of the glass tube 134 and that of the ferrule 136. In the fourth embodiment, the ferrule 136 is held concentrically with the glass tube 134 by the elastic holding parts 138A, 138B. Therefore, the ferrule 136 can be provided in a large size and thus a large difference can be provided between the inner diameter of the ferrule 136 and the outer diameter of the glass tube 134. As a result, the fitting area of the ferrule 136 and the stopper 126 increases and the movement of the discharge tube 134 is properly restricted.

The stopper 126 includes the concave portion 127 with which the periphery of the glass tube 134 comes into contact when the ferrule 136 is held by the stopper 126. The relay connector 114 includes a pair of the elastic pressing pieces 132 that can press the discharge tube 115 to the recess 127 side. The elastic pressing pieces 132 press the discharge tube 115 obliquely from the upper side and the lower side toward the concave portion 127 side, respectively. Therefore, the glass tube 134 is less likely to come off of the concave portion 127 and the ferrule 136 is properly fitted to the stopper 126.

The relay connector 114 is configured such that the relay terminal 131 is fitted into the synthetic resin holder 120. In the fourth embodiment, the resin holder 120 includes the stopper 126 and thus the relay terminal 131 does not require a stopper. Therefore, a large amount of material is not required for producing the relay terminals 131. In general, a resin is less expensive than a metal and thus material cost for the relay connectors 114 can be reduced.

### Fifth Embodiment

Next, the fifth embodiment of the present invention will be explained with reference to FIGS. 33 to 39. In the fifth embodiment, how to hold the discharge tubes 115 is different from the fourth embodiment. Other configurations are the same as the fourth embodiment. The same parts as those in the fourth embodiment are indicated by the same symbols. The same structures, functions and effects will not be explained.

[Brief Description of Grounding Member 150]

In the fourth embodiment, the ends of each discharge tube 115 are held by the relay connectors 114 that include the holders 120 and the relay terminals 131. In the fifth embodiment, as illustrated in FIGS. 33 and 34, one of the ends of each discharge tube 115 is held by the relay connector 114 same as the fourth embodiment, and the other end is held by a grounding member 150.

As illustrated in FIG. 36, the grounding member 150 includes an elongated holding plate 151 and a plurality of grounding terminals 152. The holding plate 151 is mounted to one of side edge areas of the chassis 113. The grounding terminals 152 are mounded on the front surfaces of the holding plate 151 so as to be electrically connectable. The holding plate 151 has three mounting holes 151H that are through holes for each grounding terminal 152. The holding plate 151 is a substrate or a metal plate.

As illustrated in FIGS. 37 and 38, each grounding terminal 152 is prepared by bending a metal (e.g., a nickel silver alloy) plate punched into a predetermined shape. It includes a base portion 153, a pair of elastic pressing portions 154 and a stopper 155. The elastic pressing portions 154 extend from an upper edge and a lower edge of the base portion 153 to the front, respectively, and are vertically symmetric. The stopper 155 (a displacement restricting portion that is an element of the present invention) extends from one of side edges of the base portion 153 to the front.

The elastic pressing portions are provided in an area close to a side edge opposite to the edge from which the stopper 155 extends. They are curved so as to bulge toward each other. The elastic pressing portions 154 is elastically flexible so as to widen a gap between them. The smallest gap between the elastic pressing portions 154 in the free state when the elastic pressing pieces 154 are not elastically bent is smaller than the outer diameter of the glass tube 134 of the discharge tube 115.

The stopper 155 stands from the base portion 153 in a direction perpendicular to the axis of the discharge tube 115, and includes a concave portion 156 that is formed by cutting into a substantially arch shape. The relay connector 114 in the fourth embodiment includes a pair of the guide sections 128 that are raised from the upper and lower side of the concave portion 127 of the stopper 126. In the fifth embodiment, the raised portion on the upper and the lower side around the concave portion 156 is not much raised from the base portion 153. Namely, a portion such as the guide portion 128 of the fourth embodiment is not provided. Therefore, the amount of metal material required for the grounding terminal 153 is not as much as the one that includes such a guide portion.

The base portion 153 has integrated three legs 157. Two of the three legs 157 are located between the elastic pressing portions 154 and the stopper 155 and project from the upper and the lower edges of the base portion 153, respectively, toward an opposite side (a rear surface side) from the side where the elastic pressing portions 154 and the stopper 155 are provided. The last one of the legs 157 projects from the side edge of the base portion 153 on the opposite side from the side where the stopper is provided and at a middle point between the elastic pressing portions 154 toward the opposite side (the rear surface side) from the side where the elastic pressing portions 154 and the stopper 155 are provided.

The grounding terminal 152 is not housed in a member such as a synthetic resin housing. The bare grounding terminal 152 is fixed to the holding plate 151 by soldering and the like the legs 157 that are passed through the mounting holes 151H so as to be electrically connectable (see FIG. 39). With this configuration, a plurality of the grounding terminals 152 mounted to a single holding plate 151 are electrically connectable to each other via the holding plate 151. The grounding member 150 is not connected to the power supply board and the supporting plate 151 is connected to the chassis so as to be electrically connectable.

[Mounting of Discharge Tube 115 to Grounding Terminal 152]

To mount each discharge tube 115 to the grounding terminal 152, the discharge tube 115 is held in the horizontal position and brought closer to the front of the chassis 113. Then, the end of the glass tube 134 and the ferrule 136 are fitted between the upper and the lower elastic pressing portions 154 from the front. The elastic pressing portions 154 are elastically deflected by the body 137 of the ferrule 136 so as to further open in the vertical direction. After the body 137 has passed through the area in which the gap between the elastic pressing portions 154 is the smallest, the elastic pressing portions 154 draw the body 137 into the back area of the base portion 153 side with elastic restoring force thereof and the body 137 is brought into contact with the bottom of the base portion 153. Then, the mounting of the discharge tube 115 is completed. The other end of the discharge tube 115 is mounted to the relay connector 114 in the same manner as the fourth embodiment.

The mounted discharge tube 115 is held by the relay connector 114 and the grounding member 150 at the ends thereof. Because the elastic pressing pieces 132, 154 are elastically in contact with the peripheries of the bodies 137 of the respective ferrules 136, the outer leads 135 are connected to the relay terminal 13 and the grounding terminal 152, respectively, via the ferrules 136 so as to be electrically conductive. Moreover, the glass tube 134 is pressed against the concave portions 127, 156 by the elastic restoring force of the elastic pressing pieces 154 and held. When viewed in the axial direction of the discharge tube 115, parts of the bodies 137 overlap the stoppers 126, 155. Namely, the rims of the bodies 137 on opposite sides from the sides where the conductive parts 140 are provided face the stoppers 126 in a short distance in the axial direction.

As illustrated in FIGS. 42 and 43, the grounding terminal 152 may include protective portions 551. Each protective portion 551 includes an elastic pressing piece restricting section 552 and a holding plate contact section 553. When the grounding terminal 152 is mounted on the holding plate 151 and fixed, the holding plate contact section 553 comes into contact with or close to the holding plate 151. When external force to push the elastic pressing portions 154 outward is applied, the elastic pressing portions 154 are brought into contact with the elastic pressing piece restricting sections 552 first in a process of being pushed outward. Then, when larger force is applied, the holding plate contact sections 553 support the protective portions 551 so that the protective portions 551 are not tilted. The protective portions 551 continue from the bases of the elastic pressing portions 154. To enhance the function of the holding plate contact sections 553, the holding plate contact sections 553 should be provided outside the connecting points. By providing the holding plate contact sections 553 further outside, the effectiveness can be further enhanced.

[Functions and Effects of Fifth Embodiment]

In the fifth embodiment, the stopper 126 of each holder 120 and the stopper 155 of each grounding terminal 152 hold the ferrules 136 at the ends of the discharge tube 115 in place while the discharge tube 115 is held by the relay connector 114 and the grounding member 150. Therefore, the discharge tube 115 is less likely to move in the axial direction with respect to the relay connector 114.

Namely, when force to move the discharge tube 115 from the relay connector 114 side to the grounding member 150 side is applied, the ferrule 136 mounted to the end of the discharge tube 115 on the relay connector 114 side is stopped by the stopper 126 of the holder 120. As a result, the movement of the discharge tube 115 toward the grounding member 150 side is restricted. When force to move the discharge tube 115 from the grounding member 150 side to the relay connector 114 side is applied, the ferrule 136 mounted to the end of the discharge tube 115 on the grounding member 150 side is stopped by the stopper 155 of the grounding terminal 152. As a result, the movement of the discharge tube 115 toward the relay connector 114 side is restricted. Since the movement of the discharge tube 155 toward either right or left is restricted, the tips of the outer leads 135 are less likely to hit a wall located on an opposite side from the escape openings 125 in the holding areas 123 or a side wall of the chassis 113.

The stopper 155 of the grounding terminal 150 has the concave portion 156 with which the periphery of the glass tube 134 comes into contact when the ferrule 136 is held by the stopper 155. The grounding terminal 152 includes a pair of the elastic pressing portions 154 that can press the discharge tube 115 toward the concave portion 156. The elastic pressing portions 154 press the discharge tube 115 obliquely from the upper and the lower side, respectively. Therefore, the glass tube 134 is less likely to come off of the concave portion 156 and thus the ferrule 136 is properly fitted to the stopper 155.

Furthermore, the stopper 155 and the grounding terminal 152 that makes electrical connection with the ferrule 136 are integrally provided. In comparison to the one having a stopper as a separate part from a grounding terminal, the number of parts can be reduced.

A plurality of the discharge tubes 115 are shorted to ground collectively at the ferrules 136 on the other ends via the grounding member 150. A plurality of the grounding terminals 152 included in the grounding member 150 do not require insulation. Therefore, insulation members for covering the ground terminals 152 for an insulation purpose or for separating them from each other are not required. Namely, in this embodiment, in comparison to a configuration in which the relay connectors 114 are connected to both ends of the discharge tubes 115 and the discharge tubes 115 are grounded individually, the number of parts can be reduced.

### Sixth Embodiment

Next, the sixth embodiment of the present invention will be explained with reference to FIGS. 44 to 47. In the sixth embodiment, a configuration of the holders 20 of the relay connectors in the first embodiment is modified. Other configurations are the same as the first embodiment. The same parts as those in the first embodiment are indicated by the same symbols. The same structures, functions and effects will not be explained.

[Relay Connectors 145]

As illustrated in FIGS. 44 to 47, each relay connector 145 includes the synthetic resin holder 20 and the metal relay terminal 30 housed in the holder 20.

The holder 20 includes a box portion 21 having a block-like overall shape and a wall portion 27 that protrudes from the back of the box portion 21 toward further back. Stoppers 25 are formed as a pair and in a cantilever structure that extends along outer surfaces (top and bottom surfaces) of the box portion 21 of the holder 20 toward the rear (in the same direction as an insertion direction of the relay connector 14 into the chassis 13). A distal end of each stopper 25 has a substantially right triangular prism-like retaining protrusion 25a that extends in a direction opposite to the box portion 21. On the rear surface of the box portion 21, a pair of stop surfaces 26 is provided so as to sandwich the wall portion 27. The stop surfaces 26 are provided parallel to the chassis 13 and on the right and the left sides with the stoppers 25 therebetween. Furthermore, the box portion 21 has the holding area 23 that opens from the front to the right side (the side opposite from the edge portion of the chassis 13).

The relay terminal 30 is held by the holder 20. It includes the discharge tube connecting portion 31 and the board connecting portion 33. The discharge tube connecting portion 31 includes the upper and lower elastic clipping parts 32 provided as a pair. The elastic clipping parts 32 are pieces of plates formed into a substantially arch shape. The board connecting portion 33 has a plate-like shape and projects to the rear. The elastic clipping parts 32 area inserted in the holding area 23. The board connecting portion 33 penetrates from the rear surface of the box portion 21 to an outside of the holder 20 and projects to the rear along the ball portion 27. The direction in which the wall portion 27 and the board connecting portion 33 project from the box portion 21 matches a direction perpendicular to the chassis 13 (the mounting direction of the relay connector 14 to the chassis 13).

As illustrated in FIG. 44, the relay connector 14 is mounted to the chassis 13 such that it is inserted in the mounting hole 13H of the chassis 13. It has a function for holding the discharge tube 15 and a function for connecting the discharge tube 15 to the power supply board 16. As illustrated in FIG. 44, the power supply board 16 is separated from the chassis 13 by a space 149. The holder 20 includes a protective wall portion 146 that covers the relay terminal 30 (mainly the board connecting portion 33) from the outside in an area where the space 149 is provided. In this embodiment, the space 149 between the chassis 13 and the power supply board 16 is equal to or larger than 7 mm, which is large enough for a person to put his or her finger in there. The protective wall portion 146 covers the relay terminal 30 while maintaining a predetermined space from the relay terminal 30.

The holder 20 includes a partition wall portion 147 that separates the area into the discharge tube 15 side and the power supply board 16 side. The partition wall portion 147 includes a projecting portion 148 that is a part projecting toward the discharge tube 15 side. It is configured to be able to hold the discharge tube 15. Namely, a lower surface of the discharge tube 15 can be placed on the top surface of the projecting portion 148 that projects from a part of the partition wall portion 147.

[Functions and Effects of Sixth Embodiment]

In the sixth embodiment, the holder 20 of each relay connector 145 includes the protective wall portion 146 that covers the relay terminal 30 from the outside in the space 149 between the chassis 13 and the power supply board 16. By providing the protective wall portion 146 in the space 149 between the chassis 13 and the power supply board 16, the relay terminal 30 is not bared in the space 149. As a result, the relay terminal 30 in the space 149 is preferably protected from being touched by a person in production and electrical leak or shock is less likely to occur in the space 149.

The protective wall portion 146 covers the relay connector 30 while maintaining the space from the relay terminal 30. By maintaining the space between the protective wall portion 146 and the relay terminal 30, a mold having a sufficient thickness can be used for molding. This contributes to improving manufacturing efficiency.

The holder 20 includes the partition wall portion 147 that separates the discharge tube 15 from the power supply board 16. The partition wall portion 147 includes the projecting portion 148 that projects from a part of the partition wall portion 147 toward the discharge tube 15 side. The projecting portion 148 holds the discharge tube 15. As a result, the thickness of the portion that holds the discharge tube 15 is reduced and the formability of the holder 20 improves. If an overall thickness of the partition wall portion 147 is large so as to separate the discharge tube 15 from the power supply board 16 with a large gap, a problem in molding may occur. For example, a sink mark that is a conical depression may be formed on the thick portion in the molding process. In this embodiment, by providing the projecting portion 148, such a problem is less likely to occur.

### Seventh Embodiment

Next, the seventh embodiment of the present invention will be explained with reference to FIGS. 48 to 55. In the above embodiment, the discharge tubes 115 illustrated in FIGS. 28 to 31 are used. However, discharge tubes to which ferrules 236 illustrated in FIGS. 48 and 49 are attached may be used.

Each ferrule 236 illustrated in FIGS. 48 and 49 is a single piece prepared by bending or hammering a metal (e.g., stainless steel) plate punched into a predetermined shape similarly to the ferrule 136 illustrated in FIGS. 28 to 31. The ferrule 236 has the same configuration as the ferrule 136 except for providing cutouts 249 that extend in the peripheral direction. Therefore, the same configurations will not be explained.

The ferrule 236 includes a body 237 and a conductive part 240. The body 237 has a cylindrical overall shape concentric to the glass tube 134 (see FIG. 50 for example). An inner diameter of the body 237 is slightly larger than the outer diameter of the glass tube 134.

The body 237 includes three elastic holding parts 238 that are formed by cutting out parts of the body 237 so as to form slits around the elastic holding parts. They are formed at an equal angular interval. These three elastic holding parts 238 come into contact with the outer peripheral surface of the glass tube 134.

The body 237 includes a cantilever conductive part 240 that extends from a rim thereof similarly to the ferrule 136 in the above embodiment. Each conductive part 240 includes an elongated portion 241 that continues from the font rim of the body 237 and a drum-like portion 242 that projects from a front end (a tip) of the elongated portion 241 further to the front.

The cutouts 249 that continuously extend in the peripheral direction (cutouts that extend in the axial direction of the body 237) are formed to provide elastic holding parts 238. When forming the body in the cylindrical shape, parts thereof that continue in the circumferential direction can be easily formed into the cylindrical shape. However, parts having cutouts, that is, the parts where the elastic holding parts 238 are provided, cannot be easily formed into the cylindrical shape. By providing the cutouts 249 that extend in the circumferential direction, the parts in which the cutouts 249 are provided are properly curved to form the cylindrical shape. As a result, the body 237 is easily formed so as to have a cylindrical overall shape. As the distance between the adjacent elastic holding parts 238 (in the circumference direction) becomes larger, forming of the cylindrical shape becomes more difficult. Therefore, the effectiveness of the cutouts 249 increases.

The ferrules 236 are used for discharge tubes illustrated in FIGS. 50 to 55.

The discharge tubes 315 illustrated in FIGS. 50 and 51 are prepared by attaching the ferrules 236 to linear glass tubes 134. The discharge tubes 415 illustrated in FIGS. 52 and 53 are prepared by attaching the ferrules 236 to U-shaped glass tubes 234. The discharge tubes 515 illustrated in FIGS. 54 and 55 are prepared by attaching the ferrules 236, 236 to one of ends of linear glass tubes 334a, 334b. The outer leas 135, 135 of the discharge tubes 515 on the ends to which the ferrules 236 are attached are electrically connected to the conductive parts 240, 240. At the other ends, a connection member 434 is connected between the outer leads 335, 335 to connect two glass tubes 334a, 334b with each other.

### Other Embodiments

The present invention is not limited to the above embodiments explained in the above description. The following embodiments may be included in the technical scope of the present invention, for example.

(1) The discharge tubes are not limited to the cold cathode tubes. Hot cathode tubes, xenon tubes, fluorescent tubes and the like may be used.

(2) Switching components in the display panel of the display device is not limited to TFTs. MINs (Metal Insulator Metals) and the like may be used as switching components.

(3) The display device is not limited to the liquid crystal display device. Various kinds of display devices that required lighting devices on the back of display panels can be used.

(4) To provide a means for compensating for misalignment of the relay connectors and the output terminal, each relay connector has an elongated shape substantially perpendicular to the arrangement direction of the on-board connectors and each output terminal has a plate shape parallel to the arrangement direction.

(5) The mounting direction of the discharge tubes to the relay connectors can by different from that of the on-board connectors to the relay connectors. For example, the mounting direction of the discharge tubes to the relay connectors may be substantially parallel to the plate surface of the chassis while that of the on-board connectors to the relay connectors may be substantially perpendicular to the plate surface of the chassis. The other way around may be possible. Namely, the mounting direction of the discharge tubes to the relay connectors may be substantially perpendicular to the plate surface of the chassis while that of the on-board connectors to the relay connectors may be substantially parallel to the plate surface of the chassis.

(6) The connection portion of each relay connector to the power supply board is not limited to the projecting form. It may be provided in a recess shape. In this case, the connection portion of the power supply board to the relay connector should be provided in a projecting form.

(7) Each output terminal may be provided by punching a metal material into a predetermined shape without bending afterward.

(8) The power supply configuration is not limited to the power supply board in which the electronic components are mounted on the circuit board. A configuration in which electronic components are connected by wiring without using a circuit board may be used.

(9) A means for holding the body of each ferrule is not limited to the relay connectors. A configuration (without using the relay connectors) in which the ferrules are directly attached to connectors directly mounted on the power supply board (e.g., inverter connectors) can be used. Furthermore, the ferrules may be attached to holding members provided separately from the power supply path from the power supply to the outer leads.

(10) The on-board connectors may not be provided on the circuit boards and the relay connectors may be connected to the power supply (power supply boards) via cables.

(11) The holders may be fixed to the chassis by screws or by press-fitting other than the elastic stoppers.

(12) A single or more than two elastic stoppers can be provided.

(13) The holders can be attached to the chassis from the rear side.

(14) The discharge tube connecting portion may be exposed on the outside of the outer surface of the holder other than arranging inside the holding area.

(15) The power supply may have a configuration in which the on-board connectors are mounted on the front side the circuit boards on the chassis side.

(16) The board connecting portion may be provides as a female type (a recess shape).

1. A relay connector for supplying power from a power source arranged on a rear side of the chassis having a substantially plate like shape to a discharge tube arranged on a front side of the chassis, comprising:
a holder having electrical insulation properties and mounted to the chassis; and
a relay terminal configured to be electrically connectable to said discharge tube and said power source, and attached to said holder, wherein:
said chassis and said power source are separated from each other with a gap therebetween; and
said holder includes a protective wall portion provided in said gap between said chassis and said power source, and configured to cover said relay terminal from outside.

2. The relay connector according to claim 1, wherein said protective wall portion is spaced from said relay terminal and configured to cover said relay terminal.

3. The relay connector according to claim 1, wherein:
said holder includes a partition wall portion configured to divide space into a discharge tube side and a power source side;
said partition wall portion includes a projection configured to project from a part thereof toward said discharge tube side; and
said discharge tube is supported by the projection.

4. The relay connector according to claim 1, wherein:
said holder is passed through a mounting hole of said chassis;
said holder includes an elastic stopper configured to be elastically flexible and a stop surface substantially perpendicular to a direction in which said holder passes through said mounting hole, said elastic stopper and said stop surface being provided on an outer surface of said holder; and
said holder is fixed to said chassis by sandwiching said chassis between said elastic stopper and said stop surface.

5. The relay connector according to claim 4, wherein said holder further includes a free-movement restricting portion on the outer surface on which said elastic stopper is provided so as to be fitted to an edge of said mounting hole when said holder is mounted to said chassis.

6. The relay connector according to claim 4, wherein:
said elastic stopper includes a contact surface at which said elastic stopper is in contact with the edge of said mounting hole; and
said contact surface is sloped with respect to a thickness direction of said chassis.

7. The relay connector according to claim 1, wherein:
said holder includes a holding area configured to hold an end of said discharge tube;
said holding area includes a discharge tube connecting portion of said relay terminal; and
said discharge tube is electrically connected to said discharge tube connecting portion in said holding area.

8. The relay connector according to claim 7, wherein:
said discharge tube is inserted in the holding area in a direction perpendicular to an axis of said discharge tube and a ferrule fitted onto the end of said discharge tube is held in said holding area when said discharge tube is mounted; and
said holding area includes a displacement restricting portion configured to restrict a movement of said discharge tube in a direction to displace said discharge tube from said holding area along an axial direction of said discharge tube by holding said ferrule.

9. The relay connector according to claim 7, wherein said holder includes a projecting portion projecting from one of outer surfaces of said holder perpendicular to the plate surface of said chassis and having an opening of said holding area, said projecting portion projecting along the plate surface of said chassis between said chassis and an opening edge of said holding area.

10. The relay connector according to claim 7, wherein said holder includes a tapered guide portion sloped from an opening edge of said holding area for receiving said discharge tube in a mounting direction of said discharge tube.

11. The relay connector according to claim 1, wherein:
said power source has a configuration in which on-board connectors are mounted on a rear surface of a circuit board arranged parallel to said chassis, the rear surface being opposite from said chassis, each on-board connector includes a fitting recess corresponding to a mounting hole that is a through hole provided in said circuit board, and an output terminal for power output is arranged in said fitting recess;
said holder includes a wall portion projecting toward the rear surface of said chassis and inserted into said fitting recess through said mounting hole; and
said relay terminal includes a board connecting portion provided along said wall portion and connectable to said output terminal.

12. The relay connector according to claim 11, wherein:
said relay terminal is fitted in said fitting recess and connected to said output terminal;
said relay terminal is loosely fitted in said fitting recess; and
said relay terminal is still connected to said output terminal even when said relay terminal is moved.

13. The relay connector according to claim 12, wherein:
said relay terminal is loosely fitted in said fitting recess so as to be movable in a direction in which said relay terminal is inserted into said fitting recess; and
said relay terminal is still connected to said output terminal even when said relay terminal is moved in said direction.

14. The relay connector according to claim 11, wherein said relay terminal is configured such that contact of at least one of a tip of said relay terminal and a tip of the wall portion with a rear wall of said fitting recess is restricted when said relay terminal is inserted into said fitting recess.

15. The relay connector according to claim 11, wherein said holder includes an insertion restriction portion configured to come in contact with said circuit board during an insertion of said holder into said fitting recess.

16. The relay connector according to claim 11, wherein:
said output terminal includes a base end portion, movement of which with respect to said circuit board is restricted, a flexible portion extending from said base end portion and elastically flexible, and a connection portion having a substantially U-shape, the connection portion extending from said flexible portion and capable of elastically holding said wall portion and said board connecting portion;
said connection portion includes two connecting parts;
one of the two connecting parts on a free-end side that is opposite from said flexible portion elastically comes into contact with said board connecting portion in said fitting recess; and
one of the two connecting parts on a flexible portion side elastically comes into contact with said wall portion.

17. The relay connector according to claim 1, wherein:
said power source has a configuration in which a plurality of the output terminals and a plurality of said relay terminals are arranged on the circuit board so as to correspond one to one;
each of said output terminals includes a connecting part extending in a direction substantially perpendicular to an arrangement direction of said relay connector and said output terminals;
said relay terminal includes a board connecting portion having a width larger than said connecting part and a plate-like shape parallel to the arrangement direction of said relay terminals and said output terminals; and
said board connecting portion is in contact with said connecting part.

18. The relay connector according to claim 1, wherein said holder includes a discharge tube holding portion configured to allow said discharge tube to enter from a direction substantially perpendicular to the plate surface of said chassis and a power source holding portion configured to allow said on-board connector of said power source to be fitted from a direction substantially perpendicular to the plate surface of said chassis.

19-35. (canceled)

36. A lighting device for a display device, comprising the relay connector according to claim 1.

37. The lighting device for a display device according to claim 36, wherein:
a plurality of said relay connectors are arranged along one of side edges of said chassis, the side edges parallel to each other;
a grounding member having an elongated holding plate to which a plurality of grounding terminal are mounted so as to be electrically connectable is arranged along another one of said side edges of said chassis;
a plurality of said discharge tubes having an elongated shape are arranged in parallel in a direction substantially perpendicular to said side edges;
a ferrule attached to one of ends of each of said discharge tubes is individually connected to said relay terminal of said relay connector; and
a ferrule attached to another ends of each of said discharge tubes is individually connected to said grounding terminal.

38. A display device, comprising:
the lighting device for a display device of any one of claims 36 and 37; and
a display panel arranged on a light emitting side of said lighting device for a display device.

39. A television receiver comprising a display device of claim 38.
